(19) United States
(12) Patent Application Publication
(10) Pub. No.: US 2009/0147778 A1
(43) Pub. Date: Jun. 11, 2009

(54) METHOD AND SYSTEM FOR TARGETED ADVERTISING IN A COMMUNICATION SYSTEM FOR MEDIATING VOICE AND TEXT COMMUNICATIONS

(76) Inventors: James Andrew Wanless, Toronto (CA); Mark Gelman, Thornhill (CA)

Correspondence Address: RIDOUT & MAYBEE LLP, 225 KING STREET WEST, 10TH FLOOR, TORONTO, ON, M5V 3M2, CA

(21) Appl. No.: 11/951,499

(22) Filed: Dec. 6, 2007

(51) Int. Cl. H04L 12/56; H04Q 7/20; G06Q 30/00

(52) U.S. Cl. 370/389; 455/466; 705/14

(57) ABSTRACT

A method and system for targeted advertising in a communication system for connecting voice calls is provided. In accordance one embodiment of the present disclosure, there is provided a method for targeted advertising in a communication system for connecting a voice call, the method comprising: receiving a request to connect a voice call between a first communication device and a second communication device identified by a contact identifier; establishing a voice connection between the first communication device and a Voice over Internet Protocol (VoIP) gateway; transmitting a first audio advertisement over the voice connection between the first communication device and the VoIP gateway to be played on the first communication device; establishing a voice connection between the second communication device and the VoIP gateway; and connecting the voice call between the first communication device and the second communication device.

### TECHNICAL FIELD

The present disclosure relates generally to communications, particularly to a method and system for targeted advertising in a communication system for mediating voice and text communications.

### BACKGROUND

Mobile telephones and other mobile voice-communication devices typically allow a user to input or select the name or (destination) contact identifier of contact with whom they wish to initiate communications, for example a voice call. Voice and text communications present an opportunity to provide the advertisement of goods and services, for example to participants of a voice call. Existing solutions are ineffective to the extent that they do not take into account the particular participants of a voice call.

Thus, there exits a need for a method and system for providing improved advertising in a communication system.

### BRIEF DESCRIPTION OF THE DRAWINGS

FIG. 1 is a block diagram showing a communication system in accordance with one embodiment of the present disclosure;

FIG. 2 is a block diagram of an example mobile communication device suitable for use in the communication system of FIG. 1 in accordance with one embodiment of the present disclosure;

FIG. 3 is a block diagram illustrating data connections with the communication system of FIG. 1 in accordance with one embodiment of the present disclosure;

FIG. 4 is a block diagram of a protocol architecture for use in the communication system of FIG. 1 in accordance with one embodiment of the present disclosure;

FIG. 5 is a block diagram of a targeted advertising system in accordance with one embodiment of the present disclosure; and

FIG. 6 is a flowchart illustrating operations for targeted advertising in a communication system for connecting a voice call in accordance with one embodiment of the present disclosure.

It will be noted that throughout the drawings similar features are identified by the same reference numerals.

### DETAILED DESCRIPTION OF EXAMPLE EMBODIMENTS

The present disclosure describes a method and system for providing targeted advertising in a communication system for connecting a voice call. In at least some embodiments, information about the participants to the voice call (e.g., demographic information) are used in selecting the advertising content which is delivered. In at least some embodiments, two or more advertising components may be delivered. The advertising components may be introduced into a voice communication stream and/or delivered via Short Message Service (SMS) messages, Multimedia Messaging Service (MMS) messages, instant messaging (IM) messages, and/or email messages. The advertising components may be presented to one or more or all of the participants to the voice call. The same or different advertising components may be presented to one or more or all of the participants to the voice call. The same or different advertising content may be presented to one or more or all of the participants to the voice call in the various advertising components which are delivered. The participants may be provided with a mechanism o interact with advertisers. Advertising may access and view advertising campaign information and update the participants advertising campaign parameters.

In accordance with one embodiment of the present disclosure, there is provided a method for targeted advertising in a communication system for connecting a voice call, the method comprising: receiving a request to connect a voice call between a first communication device and a second communication device identified by a contact identifier; establishing a voice connection between the first communication device and a Voice over Internet Protocol (VoIP) gateway; transmitting a first audio advertisement over the voice connection between the first communication device and the VoIP gateway to be played on the first communication device; establishing a voice connection between the second communication device and the VoIP gateway; and connecting the voice call between the first communication device and the second communication device.

In accordance with another embodiment of the present disclosure, there is provided a server for implementing a targeted advertising in a communication system for connecting a voice call, the server being connected to a plurality of telephones and voice clients over a communication network, the server comprising: a controller comprising at least one processor, for controlling operation of the server; one or more input devices connected to the processor; a communications subsystem operatively connected to the processor for communicating with the communication network; the controller being configured to receive a receive a request to connect a voice call between a first communication device and a second communication device identified by a contact identifier, establish a voice connection between the first communication device and a Voice over Internet Protocol (VoIP) gateway, transmit a first audio advertisement over the voice connection between the first communication device and the VoIP gateway to be played on the first communication device, establish a voice connection between the second communication device and the VoIP gateway, and connect the voice call between the first communication device and the second communication device.

In accordance with a further embodiment of the present disclosure, there is provided a communication device, comprising: a controller comprising at least one processor, for controlling operation of the communication device; a display connected to the processor; an audio output device connected to the processor; one or more input devices connected to the processor; a communications subsystem operatively connected to the processor for communicating with the communications network; the controller being configured to transmit instructions to connect a voice call between with a second communication device identified by a contact identifier, establish a voice connection between the first communication device and a Voice over Internet Protocol (VoIP) gateway, receive a first audio advertisement from the VoIP gateway over the voice connection, and play the first audio advertisement on the audio output device.

### System Architecture

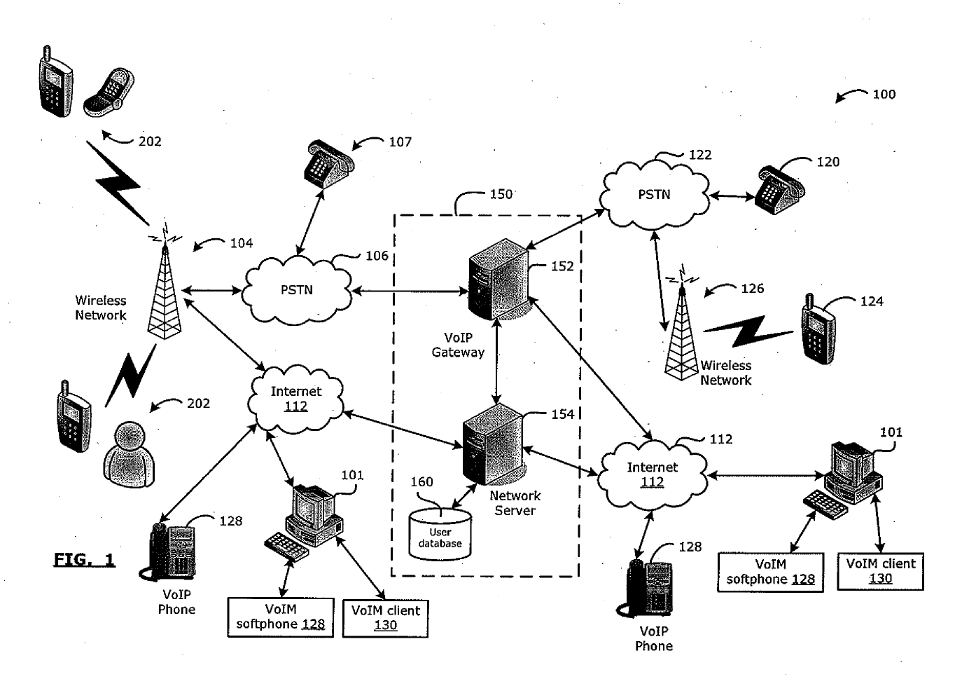

FIG. 1 is a block diagram of a communication system 100 in accordance with one embodiment of the present disclosure. The communication system 100 may be used in combination with the method and system of generating a dynamic contact list described in the present disclosure. The communication system 100 comprises a plurality of mobile communication devices 202 such as mobile telephones or voice-enabled communication devices which are connected to a wireless voice and data network 104. The wireless network 104 also connects to landline telephones 107 via a public switched telephone network (PSTN) 106. The wireless network 104 comprises a wireless network gateway (not shown) which connects the mobile communication devices 202 to the Internet 112. Voice over Internet Protocol (VoIP) phones 128 and computers 101 such as personal computers or enterprise workstations are connected to the communication system 100 via the Internet 112. The computers 101 may implement software-based VoIP phones referred to as VoIP softphones 128 and/or Voice over Instant Messaging (VoIM) clients 130 for establishing voice calls. The computers 101 may be a wireless Internet appliance such as a smartphone having both voice and data capabilities.

The wireless network 104 typically comprises a wireless Wide Area Network (WAN) implemented as a packet-based cellular network that includes a number of base transceiver stations where each of the base stations provides wireless Radio Frequency (RF) coverage to a corresponding area or cell. The wireless WAN is typically operated by a cellular network service provider that provides subscription packages to users of the mobile communication devices 202. In some embodiments, the wireless WAN conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) or various other third generation networks such as EDGE (Enhanced Data rates for GSM Evolution) or UMTS (Universal Mobile Telecommunication Systems), or various other 3.5G networks such as HSPDA (High-Speed Downlink Packet Access) or 4G networks. It will be appreciated that the wireless network types described above are provided for purposes of illustration only, and are not intended to be limiting.

The communication system 100 also comprises a communication mediation subsystem 150 (sometimes referred to as a smart route dialling network or system) comprising a Voice over Internet Protocol (VoIP) gateway 152 and a network server 154 which are connected with each other. The VoIP gateway 152 is typically implemented using software. The features of the VoIP gateway 152 may be integrated with those of the network server 154 even though they may be described as separate components. The communication mediation subsystem 150, as part of its functions, establishes and manages voice connections between callers during a voice call.

The VoIP gateway 152 is connected to the wireless network 104 via the PSTN 106, and to the Internet 112 via the network server 154. Landline telephones 107 connect to the VoIP gateway 152 via the PSTN 106. The VoIP gateway 152 is also connected to other PSTNs 122, to other wireless networks 126 via the PSTNs 122, to VoIP phones 128 and VoIP networks (not shown) over the Internet 112, and to Voice over Instant Messaging (VoIM) clients 130 running on computers or other computing devices (such as suitable equipped mobile telephones) via VoIM networks (also referred to Instant Messaging (IM) voice networks) over the Internet 112.

The computers 101 typically comprise a processor (i.e., microprocessor) for controlling its operation, a communications subsystem connected to the processor for communicating with the communications system 100, a display screen or monitor connected to the processor, one or more user input devices such as a keyboard and mouse connected to the processor for sending user input signals to the processor in response to user inputs, a memory or storage element s connected to the processor such as a hard disk drive (HDD), RAM, ROM and/or other suitable memory connected to the processor, and other suitable input and output devices (not shown) as desired or required. The memory has data and instructions stored thereon for configuring the processor and computer 101. Operating system software, software applications, and data used by the processor are stored in the memory. The applications and data configure the operation of the computer 101. Other features of the computer 101 for implementing the processes and functions described herein will be appreciated by persons ordinarily skilled in the art.

The VoIP phones 128 may be hardware-based, SIP-enabled VoIP phones (sometimes referred to as Internet Phones or Digital Phones) such as those provided by Nortel Networks Corporation and Cisco Systems, Inc., or software-based phones referred to as VoIP softphones (sometimes referred to as SIP clients, SIP softphones). Instead of a hardware-based VoIP phone, an analog telephone may be used in combination with a VoIP analog telephone adapter. The VoIP softphones may be implemented on computers 101 or suitable equipped mobile telephones with an SIP client (such as Nokia™ E and N series mobile telephones, or mobile telephones running Windows Mobile™ version 6). Example VoIP softphones are provided by CounterPath Solutions, Inc. (http://www.counterpath.com) and SJ Labs, Inc. (http://www.sjlabs.com). It will also be appreciated that some VoIP phones and VoIP softphones 128 are addressed using an SIP URI (Session Initiation Protocol Uniform Resource Identifier) whereas others may be addressed using another identifier such as a telephone number in accordance with ITU-T Recommendation E.123 for the notation of national and international telephone numbers.

The VoIP gateway 152 receives incoming voice calls from landline telephones 107 and mobile communication devices 202 via the PSTN 106. The VoIP gateway 152 also receives incoming voice calls from VoIP phones 128 and VoIM clients 130 via the Internet 112.

At least some of the mobile communication devices 202 and computers 101 are provided with a suitable Internet browser such as Internet Explorer™ from Microsoft Corporation and/or a Java™ Runtime Environment (JRE) and Java™ application or applet installed on the computer 101 for accessing a graphical user interface (GUI) of a communication mediation subsystem 150 of the communication system 100. Users access the GUI using the Internet browser or Java™ application. If a computer 101 is equipped with a VoIP softphone 128 or VoIM client 130, the computer 101 may be used to connect a voice call. If the computer 101 does not have these capabilities, then a call back or call-in telephone must be used to connect to the voice call using a call back or call-in telephone number.

A call back telephone is a telephone at which the VoIP gateway 152 will call the calling party. The call back telephone may also be a software based voice client such as a VoIP softphone 128 or VoIM client 130. Using the computer 101 or mobile communication device 202, the calling party instructs the VoIP gateway 152 to initiate an outbound ball to the specified call back telephone number or other identifier, and to route and connect the voice call to the contact identifier (i.e., destination landline or mobile telephone number, SIP URI, or IM address) once the outbound call has been answered on the call back telephone. The call back telephone may be a mobile phone, a landline or PSTN phone (such as the user's home or office telephone), a VoIP phone or softphone 128, or VoIM client 130.

A call-in telephone is the telephone from which a calling party will call the VoIP gateway 152. The call-in telephone may also be a software based voice client such as a VoIP softphone 128 or VoIM client 130. Using a computer 101 or mobile communication device 202, the calling party instructs the VoIP gateway 152 that it will receive an inbound call from a specified call-in telephone number or other identifier, and to route and connect the voice call to the contact identifier (i.e., destination landline or mobile telephone number, SIP URI, or IM address) once the inbound call has been received from the call-in telephone number. The call-in telephone may be a mobile phone, a landline or PSTN phone (such as the user's home or office telephone), a VoIP phone or softphone 128, or VoIM client 130.

For example, a voice call may be setup using the Internet browser on the computer 101, and connected using a desk phone adjacent to the computer 101 using a call back or call-in function. Alternatively, the call could be connected using the user's mobile telephone using a call back or call-in function. In the above examples, the telephone number of the desk phone or mobile telephone is provided as the call back or call-in telephone number to the communication mediation subsystem 150 using the GUI presented in the Internet browser. The technical capabilities of computers 101 required to perform the above-described functions will be readily apparent to persons ordinarily skilled in the art and will not be described herein.

The use of call-in and call back functions may be advantageous for several reasons. The call back and call-in functions allow users to use computers 101 to connect to the communication mediation subsystem 150 via its GUI. This may be advantageous where users do not have a mobile telephone with the required technical capabilities for connecting to the GUI (i.e., telephones which lack a Web browser and/or which lack the technical capabilities to execute Java™ applications/applets) to use the communication mediation subsystem 150. The use of call-in and call back functions may also result in lower costs for the voice call. For example, the cost of a calling from a given telephone (such as a mobile communication device 202) may be different than the cost of receiving a call on the same telephone depending on the rates charged by the respective carriers associated with the call. The costs may also vary between two different telephones or voice clients, for example, between a mobile communication device 202, a landline phone 107, and a VoIP phone 128 or VoIM client 130. Additionally, the computing device on which a user selects to access the GUI of the communication mediation subsystem 150 may not be a computer which is not equipped to handled voice calls (i.e., it may not have a VoIP phone 128 or VoIM client 130), in which case a call back and call-in is required.

The VIP gateway 152 is connected to the PSTN 106 via a VoIP switch (not shown) which performs translation and negotiation functions for transforming voice data passed through the PSTN 106 into digital voice data packets, receiving voice data packets from SIP-compatible VoIP phones and networks, and translating voice data packets between different VoIP protocols if required. Suitable VoIP switches are known in the art such as those provided by Nortel Networks Corporation and Cisco Systems, Inc. Thus, the VoIP gateway 152 receives voice data from the landline telephones 107 and mobile communication devices 202 in the form of SIP-compatible VoIP voice data packets via the VoIP switch.

The VoIP gateway 152 routes and connects calls to contact identifiers corresponding to landline telephones 120 via a PSTN 122. Calls to contact identifiers corresponding to mobile communication devices 124 are routed and connected via a wireless network 126 using an intermediary PSTN such as the PSTN 122. The VoIP gateway 152 also routes and connects calls to contact identifiers corresponding to instant messaging (IM) identities (i.e., using IM addresses) to computers or other computing devices running VoIM clients 130 via the Internet 112, and to contact identifiers corresponding to SIP URIs (Session Initiation Protocol Uniform Resource Identifiers) to VoIP phones 128 via the Internet 112.

The VoIP gateway 152 is configured to implement least cost routing (LCR) for calls placed from originating mobile communication devices 202 and landline telephone 107 and/or to destination landline telephones 120 and mobile communication devices 124. Intelligent least cost routing techniques are known in the art and will not be described in detail herein. Any suitable least cost routing method may be used by the VoIP gateway 152. The VoIP gateway 152 uses least cost routing to select the most cost-effective routing/connection path from the originating communication device to the contact identifier. For mobile communication devices 202, the home location and current location of the mobile communication devices 202 may be used in determining the least cost route. Typically, rate information for the various carriers is stored in an internal routing table. This rate information is typically compared against call quality information (which may also be stored in the routing table or in a separate routing table) so as to select a routing for the call which is cost effective but which will have an acceptable level of call quality or reliability.

The network server 154 may be implemented as one or more server modules and may be located behind a firewall (not shown). The network server 154 provides at least HTTP (Hypertext Transfer Protocol) and SIP (Session Initiation Protocol) connectivity. The current SIP standard is defined by Request for Comments (RFC) 3261; however the present disclosure is intended to cover all revisions, supplements, additions and replacements to this standard, whether or not explicitly described herein. The network server 154 functions as an Internet/Web server and/or application server for receiving and responding to requests from the mobile communication devices 202 or computer 101 via a suitable Internet browser such as Internet Explorer™ from Microsoft Corporation and/or a Java™ application or applet (Java™ is a trade-mark of Sun Microsystems, Inc.).

The network server 154 also functions as an SIP server for establishing an SIP session/connection with VoIP phones 128 and/or VoIP networks. As will be appreciated by persons skilled in the art, SIP is a peer-to-peer application-layer control (signaling) protocol for creating, modifying, and terminating sessions with one or more participants (i.e., for VoIP calls in this instance). Other supporting protocols are used for transmitting data during an SIP communication session after the session has been created. Session Description Protocol (SDP) describes streaming media initialization parameters for the purposes of session announcement, session invitation, and other forms of multimedia session initiation. The current SDP standard is defined by RFC 4566. The SIP sessions may be packet streams of the Real-time Transport Protocol (RTP) data carrying voice data packets. The current RTP standard is defined by RFC 3550.

Although reference has been made to particular versions of the SIP standard/protocol and some of its supporting standards/protocols, this is for the purpose of explanation only and is not intended to be limiting. It will be appreciated that the innovations described herein are intended to cover all revisions, supplements, additions and replacements to the SIP standard/protocol and its supporting standards/protocols.

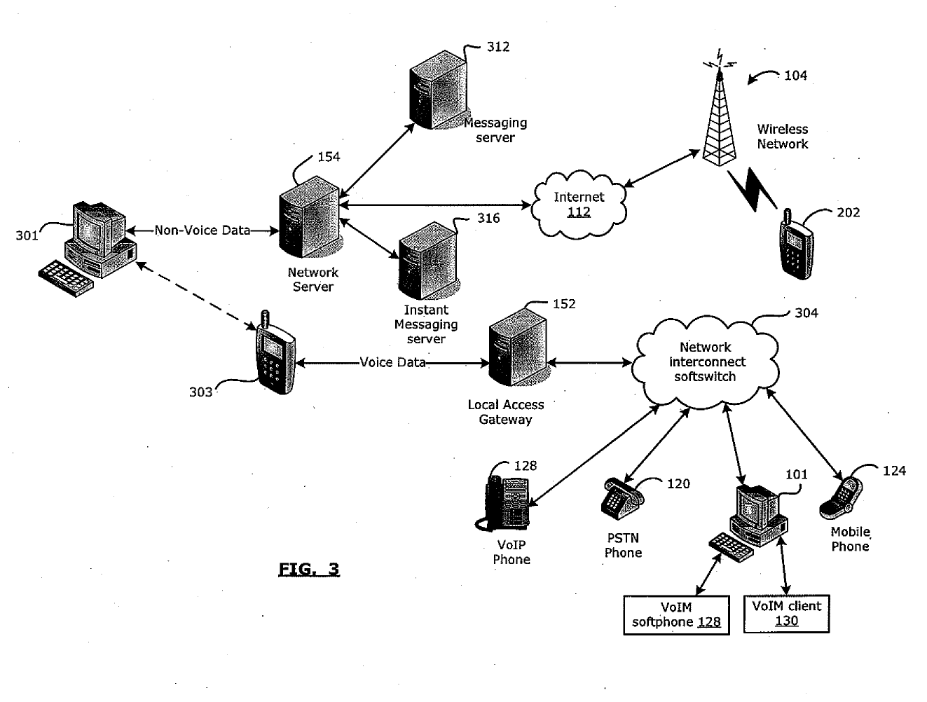

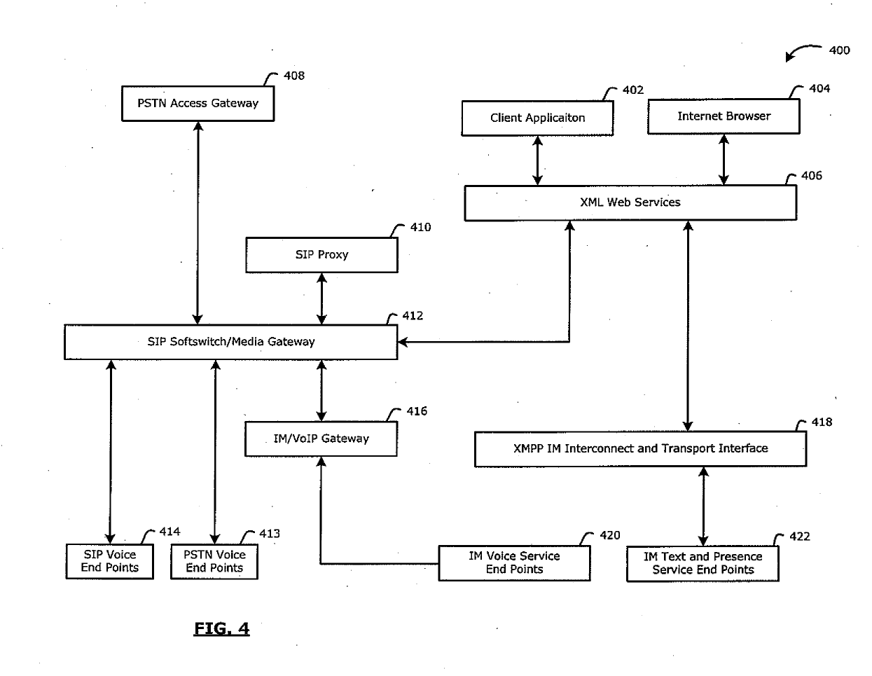

The network server 154 also implements a network interconnect softswitch 304 (FIG. 3) which interconnects and performs switching functions between the various PSTNs, VoIP, and VoIM connections to the VoIP gateway 152. The network interconnect softswitch 304 will be described in more detailed below in connection with FIGS. 3 and 4.

The network server 154 may be implemented using any suitable computer. Typically, the server computer comprises a processor (i.e., microprocessor) for controlling its operation and a communications subsystem connected to the processor for communicating with the communications network and various end points. The server computer may further comprise a display screen or monitor connected to the processor, one or more user input devices such as a keyboard and mouse connected to the processor for sending user input signals to the processor in response to user inputs, a memory or storage element s connected to the processor such as a hard disk drive (HDD), RAM, ROM and/or other suitable memory connected to the processor, and other suitable input and output devices (not shown) as desired or required. The memory has data and instructions stored thereon for configuring the processor and network server 154. Operating system software, software applications, and data used by the processor are stored in the memory. The applications and data configure the operation of the network server 154. Other features of the network server 154 for implementing the processes and functions described herein will be appreciated by persons ordinarily skilled in the art.

After the VoIP gateway 152 determines the optimal route for outgoing call using least cost routing, the network interconnect softswitch 304 connects the call to the appropriate voice end point (via PSTNs/wireless networks, VoIP, and VoIM) according to the type of connection and the selected contact identifier for the outgoing call. The outgoing call may be directed to a landline telephone 120 via a PSTN 122, a mobile communication devices 124 via the wireless network 126/PSTN 122), a VoIP phone 128 via the Internet 112, or to a VoIM client 130 on a computer or other computing device via the Internet/VoIM network.

The network server 154 is also connected to a user account database 160 which stores data user account details such as user identifiers (ID), passwords or passcodes (i.e., PINs), and user preferences. The user account database may also store one or more user contact lists for each user and/or contact identifiers for each user such as telephone numbers (e.g., for landline/PSTN phones 107, mobile telephones 202 and/or VoIP phones), IM addresses and/or SIP URIs. The technical capabilities of the respective devices may also be stored in the database 160. User preferences and settings may be stored on the network server 154 so that the settings are available from any computer 101 or mobile communication devices 202. User preferences typically include the user's current location (for example, in terms of the country and area code/city code (if any), the conditions under which the VoIP gateway 152 will connect outgoing calls (for example, all, none, or long distance), the conditions under which the user's cellular or other wireless carrier network will connect outgoing calls, whether a call back or call-in number should be used, a call back number, and a call-in number (which may be the same as the call back number). If the user's cellular carrier is used for connecting outgoing calls, the communication mediation subsystem 150 provides a centralized, online contact list and call dialling service, but does not connect or route calls or provide least cost routing services.

User preferences may also include caller identification (ID) settings. The caller ID setting allows the telephone number or other identifier which is displayed on the telephone of the called party, or within the voice client (i.e., VoIP softphone 128 or VoIM client 130) of the called party to be set to a number specified in the caller ID settings. For example, the caller ID settings may provide the option to display the user's mobile telephone number, business telephone number, a follow-me number, or any other number provided by the user. A caller name may also be provided and displayed to the called party along with the specified telephone number. Alternatively, the caller ID settings may allow the caller number and/or name to be displayed as “private”. As will be appreciated by persons of ordinary skill in the art, a follow-me number is a phone number that, when called, is terminated onto a unified messaging or PBX (Private Branch exchange) system which then does a lookup based on a set of user defined preferences to determine where the call should be forwarded to. These preferences can determine the number or other contact identifier to which a voice call should be forward in accordance with factors such as the time of day, day of the week, etc. or the identity of the person making the call.

It will be appreciated that the communication system 100 shown in FIG. 1 is illustrative of a suitable communication system for implementing the method of the present disclosure, and that other configurations are possible. Although some communication networks such as the wireless networks 104, 126 and PSTNs 106, 122 have been represented as separate networks, it will be appreciated that in some embodiments and/or in some use case scenarios, one or more of the networks of each respective type may be the same. Furthermore, although individual system components are shown, it will be appreciated by persons of ordinary skill in the art that certain system components may have multiple instances, for example a plurality of local access (VoIP) gateways may be used to cover predefined geographic regions. In addition, each VoIP gateway 152 may be connected to a plurality of PSTNs, VoIM networks and wireless networks.

### Example Mobile Communication Device

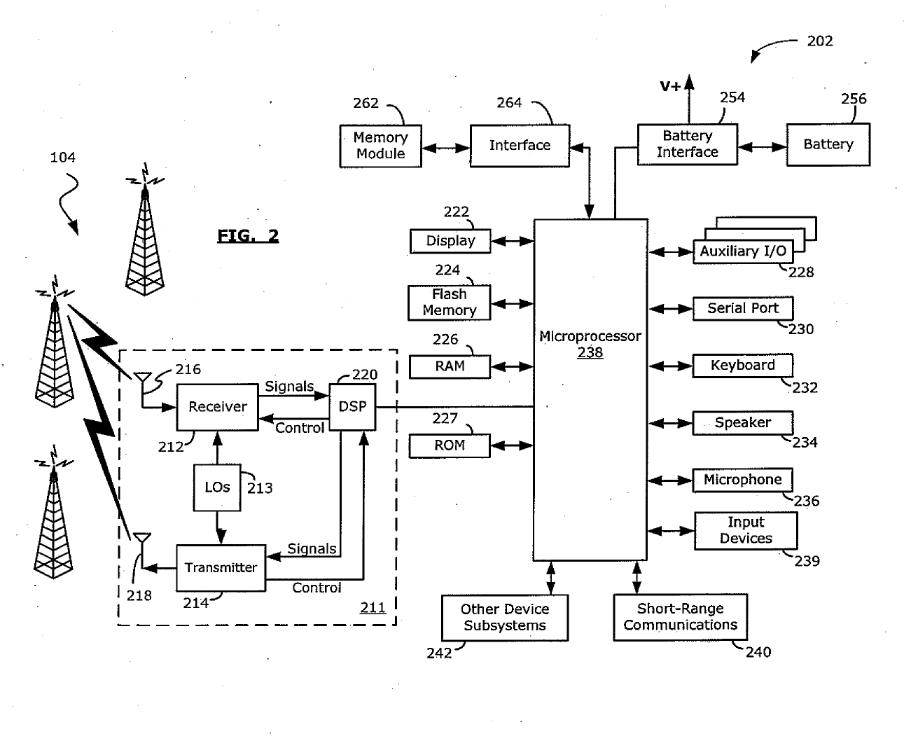

FIG. 2 is a block diagram of an example mobile communication device 202 suitable for connecting to the communication system 100, and which may be used in combination with the method and system of targeted advertising described in the present disclosure. The mobile communication device 202 is a two-way communication device having data and voice communication capabilities, and the capability to communicate with other computer systems, for example, via the Internet. Typically, the mobile communication device 202 is a handheld device such as a mobile telephone.

The mobile communication device 202 comprises a microprocessor 238 which controls the overall operation of the mobile communication device 202 and a communication subsystem 211 connected to microprocessor 238 for exchanging radio frequency signals with the wireless network 104. Communication functions, including at least voice and data communications, are performed through communication subsystem 211. The communication subsystem 211 comprises at least a WAN communication subsystem for two-way communication with the wireless WAN and passably a wireless local area network (WLAN) communication subsystem two-way communication with a WLAN via the access points. The communication subsystem 211 comprises includes a receiver 212, a transmitter 214, and associated components, such as one or more antenna elements 216 and 218 (which may are commonly embedded or internal), local oscillators (LOs) 213, and a processing module such as a digital signal processor (DSP) 220. As will be apparent to those skilled in the field of communications, the particular design of the communication subsystem 211 depends on the wireless network 104 in which mobile communication device 202 is intended to operate.

The mobile communication device 202 may communicate with any one of a plurality of fixed transceiver base stations of the wireless network 104 within its geographic coverage area. The mobile communication device 202 may send and receive communication signals over the wireless network 104 after the required network registration or activation procedures have been completed. Signals received by the antenna elements 216 and 218 through the wireless network 104 are input to the receiver 212, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 220. In a similar manner, signals to be transmitted are processed, including modulation and encoding, for example, by DSP 220. These DSP-processed signals are input to the transmitter 214 for digital-to-analog (D/A) conversion, frequency up conversion, filtering, amplification and transmission over the wireless network 104 via the antenna 218. The DSP 220 not only processes communication signals, but also provides for receiver and transmitter control. For example, the gains applied to communication signals in the receiver 212 and the transmitter 214 may be adaptively controlled through automatic gain control algorithms implemented in the DSP 220.

Network access is associated with a subscriber or user of the mobile communication device 202 via a memory module 262, such as a Subscriber Identity Module (SIM) card for use in Global System for Mobile communications (GSM) networks, a Removable User Identity Module (RUIM) card for use in CDMA2000 (Code Division Multiple Access 2000) networks, or a Universal Subscriber Identity Module (USIM) card for use in UMTS (Universal Mobile Telephone Systems) networks, to be inserted in or connected to an interface 264 of the mobile communication device 202 in order to operate in the wireless network 104. Other memory modules supporting other wireless networks types may also be used. Alternatively, the memory module 262 may be a non-volatile memory which is programmed with configuration data by a service provider so that the mobile communication device 202 may operate in the wireless network 104.

The mobile communication device 202 also includes a battery interface 254 for receiving one or more rechargeable batteries 256. The battery 256 provides electrical power to the electrical circuitry in the mobile communication device 202, and the battery interface 254 provides a mechanical and electrical connection for it. The battery interface 254 is coupled to a regulator (not shown) which provides power V+ to the circuitry of the mobile communication device 202.

The microprocessor 238 is also connected to additional device subsystems such as a display 222 which may be a backlight light emitting diode (LED) screen or liquid crystal display (LCD) screen, a flash memory 224, a random access memory (RAM) 226, a read-only access memory (ROM) 227, auxiliary input/output (I/O) subsystems 228, a data port such as serial port 230, a keyboard or keypad 232, a speaker 234, and a microphone 236, one or more other user input devices 239 such as a navigation or directional pad, a touch screen, a clickable trackwheel (thumbwheel) or trackball, a short-range communications subsystem 240, and any other device subsystems generally designated at 242. Headphones may be connected to the device 202, for example using the auxiliary input/output (I/O) subsystems 228 or data port such as serial port 230, as an alterative audio output device to the speaker 234.

The microprocessor 238 operates under stored program control and executes computer programs or code modules stored in memory such as persistent memory such as the flash memory 224. The memory has data and instructions stored thereon for configuring the processor and mobile communication device 202. The computer programs or code modules comprise two general categories of software: operating system software and software applications. Those skilled in the art will appreciate that the operating system, specific device applications, or parts thereof, may be temporarily loaded into volatile memory such as the RAM 226. The RAM 226 is used for storing runtime data variables and other types of data or information, as will be apparent to those skilled in the art.

The mobile communication device 202 is provided with a graphical user interface (GUI) for controlling the operation of the device. Other applications may be preloaded on the mobile communication device 202 for use via the GUI. The mobile communication device 202 is provided with an Internet/Web browser such as Internet Explorer™ from Microsoft Corporation or other suitable browser. In some embodiments, the mobile communication device 202 is provided a Java™ Runtime Environment (IRE), also known as the Java™ Virtual Machine, for running Java™ applications. Additional applications may be subsequently loaded onto the mobile communication device 202 via download over the wireless network 104, the auxiliary I/O subsystem 228, the serial port 230, the short-range communications subsystem 240, or any other suitable subsystem 242, and installed by a user in RAM 226 or persistent store such as flash memory 224 for execution by the microprocessor 238.

The mobile communication device 202 may also include a personal information manager (PIM) application having the ability to organize and manage data items relating to user such as, but not limited to, instant messaging, email, calendar events, contacts, voice mails, appointments, and task items. The PIM application has the ability to send and receive data items via the wireless network 104. The functions of the PIM application may also be provided via one or more separate program applications.

The short-range communications subsystem 240 provides for communication between the mobile communication device 202 and other systems or devices. The short-range communications subsystem 240 may comprise an infrared transceiver and/or a Bluetooth® communication module for communication with similarly-enabled systems and devices (Bluetooth® is a registered trademark of Bluetooth SIG, Inc.).

### Connections and Communications Architecture

Referring now to FIGS. 3 and 4, the data connections and communications architecture of the communication system 100 will now be described. FIG. 3 is a block diagram illustrating the data connections between a computing device 301 for connecting to the GUI of the communication mediation subsystem 150 of the communication system 100, and a voice-enabled communication device 303 for establishing a voice call in accordance with one embodiment of the present disclosure. The computing device 301 may be a personal computer 101 or a handheld mobile communication device 202 having at least data capabilities such as a smartphone. The communication device 303 may be a telephone or voice client such as a PSTN or landline telephone 107, mobile telephone 202, VoIP phone 128, or a VoIM client 130. Voice and non-voice data streams have been shown separately for purpose of illustration, however these streams may occur together in the communication system 100. The computing device 301 and communication device 303 may be the same or different devices. For example, a mobile communication device 202 having both voice and data capabilities or a computer 101 having a VoIP softphone 128 or VoIM client 130 for establishing the voice call may be used to provide the functionality of the computing device 301 and communication device 303 described herein.

Voice data is transmitted between the communication device 303 and a local access VoIP gateway 152 via a PSTN (not shown). The VoIP gateway 152 is connected to a network interconnect softswitch 304 which interconnects and performs switching functions between the various PSTNs, VoIP, and VoIM connections to the VoIP gateway 152. The network interconnect softswitch 304 connects voices call from the communication device 303 to the appropriate end point according to the type of connection and the relevant contact identifier for the voice call. An outgoing voice call may be connected to a landline telephone 120 via a PSTN 122, a mobile communication device 124 via the wireless network 126/PSTN 122, a VoIP phone 128 via the Internet 112, or a VoIM client 130 on a computer 101 or other computing device via the Internet 112 and the respective VoIM network.

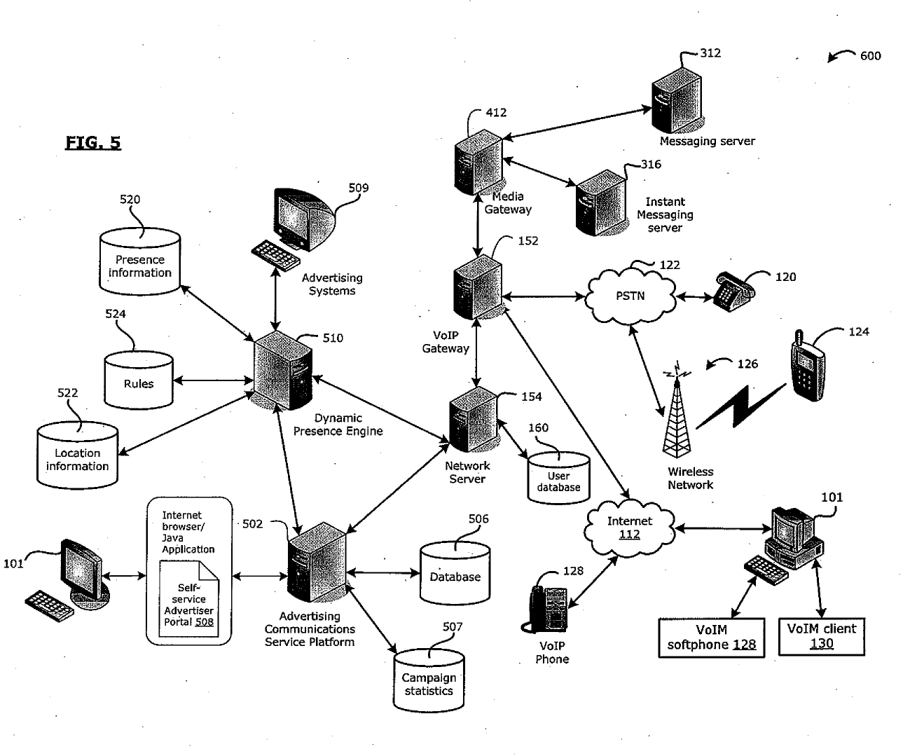

Non-voice data is transmitted between the computing device 301 and the network server 154. Instant messaging text and presence information and other data, such as emails, Short Message Service (SMS) messages, Multimedia Messaging Service (MMS) messages, may be transmitted between the computing device 301 and the network server 154, and from the network server 154 to the appropriate end point such as a messaging server 312 (FIG. 5) for emails sent to an email address (for example, a Microsoft Exchange™ server), a wireless data network 104 for SMS and MMS messages sent to a mobile telephone 202, and an instant messaging server 316 (FIG. 5) for IM text and presence information sent to an IM client or VoIM client. Intermediary networks and connections have not been shown for purposes of simplicity.

Thus, it will be appreciated that three data streams may be generated: (1) a voice data stream for transmitting voice data packets compatible with SIP, including VoIP voice data packets and non-VoIP voice data packets encoded in accordance with IM network proprietary encoding protocols which are compatible with SIP; a (2) data stream for transmitting text and presence information between the system and respective IM networks; and a (3) data stream for transmitting other data such a SMS (Short Messaging System) and MMS (Multimedia Messaging System) messages.

FIG. 4 is a block diagram of the communications architecture 400 used in the communication system 100 for mediating voice and text communications in accordance with one embodiment of the present disclosure. A user may access the communication mediation subsystem 150 via a graphical user interface (GUI) displayed on a computing device, such as a computer 101 or mobile communication device 202 having data functionality. The GUI may be provided via an Internet browser 404, such as Internet Explorer™, presenting an extensible HyperText Markup Language (XHTML) document or a Java™ application or applet 402. The Internet browser 404 and client application 402 receive data from XML (extensible Markup Language) Web services 406 which are connected to an SIP Softswitch/Media Gateway 412 and an XMPP (extensible Messaging Presence Protocol) Instant Messaging (IM) Interconnect and Transport interface 418. The XMPP IM Interconnect and Transport interface 418 connects to IM text and presence service end points 422 of the IM networks/services which have agreed to share IM text communications and/or presence information and with the communication mediation subsystem 150. Separate presence services may also connect to the communication mediation subsystem via the XMPP IM Interconnect and Transport interface 418.

Through the above-described connections, instant messaging text and presence information may be provided to the user via the GUI. It will be appreciated that the IM text communications and presence information do not originate with the communication mediation subsystem 150, but are provided to the communication mediation subsystem 150 by respective IM networks and re-transmitted to GUI on the user's mobile communication device 202 or computer 101. The communication mediation subsystem 150 relays instant messaging text and presence information in accordance with defined rules and preferences as explained in more detail below.

The network server 154 is connected to, or comprises a number of functional modules, comprising an SIP proxy server 410, an SIP Softswitch/Media Gateway 412, and an IM/VoIP gateway 416. These elements comprise the network interconnect softswitch 304 previously described in relation to FIG. 3.

The SIP proxy server 410 connects users to the communication mediation subsystem 150 using an SIP client on the computing device. The SIP proxy server 410 establishes SIP sessions between the computing device and VoIP phones 128 and other SIP clients. If a voice call is connected to a softswitch through a gateway and then to a VoIP end point (SIP URI) then the SIP proxy server 410 establishes an SIP session between the SIP Softswitch/Media Gateway 412 and VoIP phone/client 128, and not between the mobile communication device 202 and the VoIP phone/client 128.

The SIP Softswitch/Media Gateway 412 is connected to the SIP proxy server 410. The SIP Softswitch/Media Gateway 412 performs two primary functions. The first function is SIP session setup to establish the route for communications. The second function is media transport. Media transport is typically performed in the case that either one of the end points is behind a Network Address Translation (NAT) firewall, or the compression algorithm used for the media stream is different between the originating and destination end points (for example, the call starts as G.729a and ends as G711 or GSM). The SIP session is comprised of signalling and media data streams. As noted above, the media stream typically conforms to the Real-time Transport Protocol (RTP). RTP data can often pass peer-to-peer in the case that each end point has an external IP address and is transmitting the RTP data using the same compression algorithm.

The SIP Softswitch/Media Gateway 412 connects all types of end points to the communication mediation subsystem 150. The SIP Softswitch/Media Gateway 412 connects to a PSTN access gateway 408 and PSTN termination end points 413 (such as landline/PSTN phones 120, and mobile phones 124 via wireless networks 126 connected to PSTNs) for transmitting voice data between originating telephone or voice client and the PSTN voice end points 413. The PSTN access gateway 408 comprises a number of local access gateways to which calling parties may connect to the system 100 via a PSTN telephone 107 or mobile communication device 202 using a direct call, call-in or call back when conducting a voice call. The SIP Softswitch/Media Gateway 412 is also connected to the SIP voice termination end points 414 (i.e., SIP-based VoIP phones 128) for transmitting voice data between the SIP voice end points and the originating telephone or voice client.

The SIP Softswitch/Media Gateway 412 is also connected to the IM/VoIP gateway 416. The IM/VoIP gateway 416 connects calling parties to called parties using VoIM clients 130. Each IM network may use its own proprietary media encodation protocol. If a proprietary media encodation protocol is used, outgoing voice data packets of the VoIP gateway 152 are transcoded to generate voice data packets which are compatible with the proprietary protocol of the destination IM/VoIM network in order for a voice call to be passed between the originating telephone or voice client and the destination VoIM client 130.

The IM/VoIP gateway 416 comprises a transcoder which transcodes SIP-compatible voice data packets received from the VoIP gateway 152 into VoIM voice data packets that are compatible with the respective VoIM networks in accordance with the respective VoIM network encodation protocol. After transcoding the SIP-compatible voice data packets into a format that is compatible with the respective VoIM network, the transcoded voice data packets are transmitted to the respective VoIM network.

The transcoder of the IM/VoIP gateway 416 also transcodes VoIM voice data packets received from the respective VoIM networks in the proprietary encodation protocols into SIP-compatible voice data packets suitable for the VoIP gateway 152. After transcoding the VoIM voice data packets into SIP-compatible voice data packets, the transcoded SIP-compatible voice data packets are transmitted to the respective VoIP gateway 152, and from the VoIP gateway 152 to the originating telephone or voice client. If the encodation of the voice data packets of the different VoIM networks is the same (for example, if a standard for VoIM voice data packets is achieved), the transcoding step may be omitted when transmitting voice data packets between VoIM clients 130 provided that standard voice data packets are used by the communication mediation subsystem 150 and the respective VoIM networks.

### Targeted Advertising System

Referring now to FIG. 5, a targeted advertising system 500 in accordance with one embodiment of the present disclosure will be described. The targeted advertising system 500 comprises an ACSP (Advertising Communications Service Platform) 502 which cooperates with a communication mediation subsystem 150 of the communication system 100. The ACSP 502 is connected to the network server 154 of the communication mediation subsystem 150.

The dynamic presence engine 510 is connected to the network server 154. Alternatively, the dynamic presence engine 510 may be implemented as part of the network server 154. The dynamic contact engine 510 consolidates and manages presence information 520 relating to users of the communication mediation subsystem 150 and advertiser systems 509 connected to the system 500. The dynamic contact engine 510 may also consolidate and manages location information about users and optionally contact information.

Users connect to the dynamic presence engine 510 via a computing device 301 which provides a graphical user interface (GUI). The computing device 301 connects to the dynamic presence engine 510 through the network server 154 via the Internet 112 or other communications network. The GUI may be a web-based portal provided via a series of web pages in an Internet browser 404 or client application 402 on the computing device 301. The client application 402 may be a Web application implemented using Java™ (i.e., a Java™ application or applet) or other suitable programming language. The computing device 301 may be a personal computer 101, an Internet enabled handheld mobile communication device 202 such as mobile telephone, personal digital assistant (PDA), or smartphone, or a navigation device such as a GPS device through an application installed on any of these devices where the application provides a visual user interface in place of the Internet browser 404. Additionally a subset of this information may be accessible through a voice user interface (not shown) where a visual user interface is not available, such as when using a mobile communication device 202 but where data network capabilities are temporarily unavailable rendering the Internet browser 404 unusable. The voice user interface is typically an interactive voice recognition (IVR) user interface where the user creates input through the use of voice recognition and the system returns results based upon input presented using text to speech voice synthesis. Suitable IVR systems are known in the art and will not be described herein. The underlying functionality of the system 600 is the same, except that voice input by the user replaces input via input devices of the computing device 301 (i.e., keyboard, mouse, trackwheel, trackball or touch screen), and that audio announcements via text to speech voice synthesis replace the GUI on the computing device 301.

Location information concerning the user's current geographic location may be determined in different ways. Location information may be provided by the user location information provided by the user (for example, if the user's device does not have location services or if the user does not wish to use such services, for example, because of privacy concerns) and stored by the dynamic presence engine 510, for example via the GUI on the computing device 301. The user may specify the current location, for example in a temporary location field, or specify that they are in a home or fixed location, or at one of a number of predetermined locations. Alternatively, the location of the user may be determined by a location server providing location services. If the user or the user's wireless carrier/service provider will have enabled location based services these services may be used to enable the real-time update of the user's location to determine. The location may also be determined by a Global Positioning System (GPS) using information provided by a GPS transmitter such as in a mobile telephone or GPS device of the user, an assisted GPS, or a location server of a wireless communication network which determines location by triangulation based on location information provided by a plurality of transceiver base stations of the wireless communication network. Assisted GPS is a service provided by many wireless telecommunications carriers in which a combination of GPS information obtained from satellites is combined with triangulation information from transceiver base stations of the wireless network 104 to determine the location of the mobile communications device 202.

The presence information 520 may be obtained from one or more of a number of sources of presence information including instant messaging (IM) presence servers, non-IM presence servers, presence information stores or other sources of presence information. At least some of the IM presence servers may be provided by the VoIM networks connected the VoIP gateway 152 and communication mediation subsystem 150. The IM/VoIM networks sharing presence information may be MSN Messenger™, Yahoo! Messenger™ with Voice, Google Talk™, AOL Messenger™, Gizmo Project™ or enterprise IM networks/services or other presence services.

The IM presence servers manage and transmitted presence information between IM users. Presence information may be implemented using open standards protocols for such as XMPP (extensible Messaging Presence Protocol), SIMPLE (Session Initiation Protocol for Instant Messaging and Presence Leveraging Extensions) and SIP (Session Initiation Protocol), or proprietary IM protocols such as that of Microsoft's MSN™ network. The dynamic presence engine 510 may collect presence information 520 from any open source or proprietary instant messaging network. Suitable methods of interconnecting to open source and proprietary instant messaging networks are known in the art, for example, for accessing presence information of respective IM networks. The present disclosure is not directed to any particular method of interconnecting between open source and proprietary instant messaging networks and so will not be described in detail herein. Examples are described at http://en.wikipedia.org/wiki/Instant messaging as at Nov. 30, 2007. Moreover, the method of interconnecting between instant messaging networks does not affect the use of presence information sent or received, and does not affect the way in which presence information is used in the present disclosure.

In at least some embodiments, the communication mediation subsystem 150 may provide instant text messaging/chat capabilities. In such embodiments, the communication mediation subsystem 150 relays instant messaging text communications between IM users of the same or different IM networks.

As described above in connection with FIGS. 3 and 4, instant messaging text and presence information may be provided to the user, however the IM text communications and presence information do not originate with the communication mediation subsystem 150. IM text communications and presence information are provided to the communication mediation subsystem 150 by respective IM networks and re-transmitted to the computing device 301 for display within the GUI. The communication mediation subsystem 150 relays instant messaging text and presence information in accordance with defined rules 524 and preferences.

The rules 524 governing the access and use of presence information 520 are applied by the dynamic presence engine 510 to filter the presence information which is used when implementing a method of providing targeted advertising, for example to determine the advertisers' availability. The rules 524 are defined to ensure that the use of presence information complies with the policies and terms of use of the various IM/VoIM networks, and that only presence information of IM contacts (i.e., users or advertisers) who have agreed to share presence information are used, among other things.

Typically, contacts and IM networks are invited to share presence information and must accept the invitation and agree to share presence before the dynamic presence engine 510 may access presence information concerning those contacts and IM networks, and before the user can view the presence information of their contacts in the GUI. Some users and advertisers may choose to share presence while others may not.

In at least some embodiments, a transcoder (not shown) transcodes presence information from an open source or proprietary instant messaging network protocol of one IM network to that of another IM network. Transcoding presence information between the various encodation protocols allows presence information to be shared and transmitted between IM users of the same or different IM networks regardless of the originating open source or proprietary instant messaging network encodation protocol. The present disclosure is not directed to any particular method of transcoding presence information between open source and proprietary instant messaging network encodation protocols and so will not be described in detail herein.

The presence information 520 may be any presence state published by a user or advertiser to indicate a current communication status. This published state indicates the user's or advertiser's availability and willingness to communicate. The presence information 520 may relate to the availability to take a voice call, in particular the availability to take a voice call on a particular telephone number (e.g., at a respective landline telephone, mobile telephone or VoIP phone), at an IM address/identity (for a VoIM client 130), or an SIP URI (for a VoIP phone or softphone 128). Current standards support a rich choice of additional presence attributes that can be used for presence information, such as user mood, location, or free text status. While presence information 520 may relate to “online” status on an IM network, it is limited to “online” status.

The presence information 520 change based upon a number of factors including:
(a) an actual state of the user or advertiser—this may be determined by the state of an IM/VoIM client or their computing device or mobile telephone connected to the system 500. This may include, but is not limited to, whether user or advertiser is online (i.e., signed into an IM network), whether the respective computing device 301 is turned on or off, and whether the resource is occupied (i.e., telephone line is busy);
(b) manual updates affected by the user or advertiser where a specific presence status is selected to be shown; and
(c) automated updates affected by the user or advertiser based on rules such as time of day.

Updated presence information 520 (and possibly contact information) may be received via synchronization with a computing device such a user computing device 301 or advertiser system 509 via pushed updates from calendar entries of a calendaring system (which may be implemented by the messaging server 312 as part of a PIM (personal information manager) application such as Microsoft Outlook™ using Microsoft Exchange™). These updates may used to provide or update presence information 520 about a user or advertiser, for example providing status, availability etc. A calendar change reflects a change in the presence information 520 that may be seen by the system 600.

In at least some embodiments, presence status may be changed manually or automatically using rules such as opening hours, priority of relationship between an advertiser and different users. The process by which such updates are implemented is unrelated to the present disclosure and so will not be described in detail herein.

While presence information 520 has been primarily described in the context of IM presence information from IM networks, other sources of presence information may be provided and association with contact information any one of the contact sources described above. Other sources of presence information may be an enterprise presence service provided via proprietary services or third party services used by the enterprise. A presence service is a network service which receives stores and sends presence information to users or enterprise subscribing to the presence service. The presence service may be implemented as a single server or have an internal structure involving multiple servers and proxies.

In at least some embodiments, the presence information 520 may be used by the communication mediation subsystem 150 to determine which contact identifier of the dynamic contact in the contact list should be used when connecting a voice call. In such embodiments, presence information 520 is associated with the available contact identifiers for the one or more parties to be called. For example, the presence information 520 may indicate that a user is “At Work” and so the office telephone at the contact's place of business should be used to connect the voice call. Thus, presence information 520 may be used to determine which contact identifier of a contact should be dialled without user input. It will be appreciated that presence information 520 is not created by the communication mediation subsystem 150, but is used as the basis for rules in voice call routing connection so as to make a routing decision in respect of the called party, i.e. to choose the appropriate communication channel and associated contact identifier.

When connecting a voice call, a method of targeting advertising is implemented by the ACSP 502 to provide for the retrieval, delivery and placing of advertising in voice and messaging communication services. The advertisements may take the form of one or more of: (1) pre-recorded audio advertisements (“ads”) which are similar to advertisements on a commercial radio station; (2) text advertisements in the form of SMS (Short Messaging System) text messages delivered to mobile telephones having text messaging functionality and landline telephones having call display functionality; and (3) multimedia advertisements comprises audio, plain, text, rich text, image and/or video in the form of MMS (Multimedia Messaging System) messages delivered to mobile telephones having MMS functionality; (4) an IM message comprising a text advertisement or multimedia advertisement to an IM/VoIM client (e.g. Google Talk™ etc.); (5) an email message comprising a text advertisement or multimedia advertisement to an email address; and (6) “click to communicate” advertisements/services in which voice calls are routed and connected to an advertiser using traditional PSTN (public service telephone network) facilities, using VoIP (Voice over Internet Protocol) or VoIM (Voice over Instant Messenger) networks. Each of the advertisement components are typically linked by content (i.e., having related content) or by advertiser, however relationships between advertisement components having different content and/or having different associated advertisers may be defined. This relationship may be used to select the advertisement components to be inserted within a communication.

The ACSP 502 may combine two or more of these advertising components into an advertising campaign. For example, a (1) pre-recorded audio advertisement may be combined with (2) an SMS messages, an MMS message or IM message comprising a text advertisement or multimedia advertisement, and/or a (3) “click to communicate” advertisement.

In some embodiments, the ACSP 502 comprises two layers related to the placing of advertising within communications services. The first layer is ad insertion into the communication stream. Advertising components are inserted into the communication streams in a manner which depends on the type of advertising component(s) relevant to the communication service/channel of the calling party and/or the called party. The second layer is a self-service advertiser portal 508. Each of these layers will be described in more detail below.

It will be appreciated that not all mobile and landline telephones may have the functionality required for all of the above-described types of advertising components, in which case any unsupported advertising components inserted into the communication stream are typically ignored. For example, not all computers or mobile telephones used to connect to the system 500 will have an IM/VoIM client 130, or may not have an IM/VoIM client whose respective IM/VoIM network which participates in the system 500. Typically, the technical capabilities of the calling party and the one or more called parties are used in determining which of the advertising components will be inserted into the communication stream. The system 500 determines the type of connection(s) to the system 500 and may adapt the modes of delivery of the advertisements based on the capabilities of the respective party. For example, if a caller is connected via a landline/PSTN telephone 107 the system 500 will not send an IM message including an advertisement since the telephone 107 does not have an IM connection with the system 500 and therefore cannot receive an IM message. In some cases, the advertisement may still be sent but will be ignored, for example, an SMS text message may be sent to a landline/PSTN telephone 107 will be if the landline/PSTN telephone 107 cannot interpret the text message.

### Pre-Recorded Audio Advertisements

When connecting a voice call, pre-recorded audio advertisements are inserted into the voice communications channel and enunciated (played or announced) to one or both of the calling party and the called party. The communications channel can be a call being made from a traditional landline telephone 107, a VoIP phone 128, a mobile telephone 202, from a VoIP softphone running on a computer 101 or mobile PDA/telephone or from a VoIM client 130 of a VoIM service such as Google Talk™, MSN Messenger™ or AOL Instant Messenger™. At a point in the communication process, the audio advertisement is played to one or both of the calling party and the called party (the party to whom the call was placed). The audio advertisement may be played at any time whether it is before, during or after the voice call connection. Typically, the audio advertisement is played is prior to the voice call being connected.

The audio advertisement is chosen from available advertisements on a database 506 of the ACSP 502 based on (i) demographic information related to either the calling or called party (i.e., the one being targeted by the advertising), or (ii) a combination of the demographic information relating to the calling party and the one or more called parties. The demographic information may comprise: geographic location, stated preferences, learned preferences and any other demographic information which can be attributed to the individual calling party and/or one or more called parties. Other demographic information may come from shared sources such as social networking sites (such as Facebook™, MySpace™, etc.) where information about an individual is collected to use for the specific purpose of targeting of advertisements. Other shared sources of demographic information about individuals may be used, including but not limited to, those used for targeted advertising by online advertisers, for example by online search engines or other Internet sites implementing targeted marketing when selecting advertisements for sponsored links, pop-up advertisements, banner advertisements, email-based advertisements or other types of online advertisements. It will be appreciated that in some instances, little or no demographic information may be known about the called party or parties, in which case the demographic information is limited to the calling party, i.e., the user of the communication mediation subsystem 150.

The audio advertisement is inserted into the stream of communication for each individual. For example, the audio advertisement may be played before the call is connected for a conversation between the calling party and the one or more called parties. If the audio advertisement is played prior to the call being connected, different audio advertisements may be selected and played to the calling party and each of the one or more called parties. This allows each party to the call to hear a targeted audio advertisement based on the individual's demographic information. If a group of people are being connected into a group conference call and the audio advertisement is played prior to the call being connected, an audio advertisement may be selected and inserted for each person in the group so that each person will hear an audio advertisement selected based on their own demographic information, or based on the combined demographic of the group.

Typically, audio advertisements may be inserted in all voice communication streams and will be heard by all calling parties and optionally called parties since most, if not all, voice communication streams can support this functionality, i.e., most mobile telephones 202 and landline PSTN 107 and VoIP telephones 128, VoIP clients/softphones and VoIM service clients 130.

### SMS (Short Messaging System) Text Message Advertisements

If the user's telephone or voice client supports SMS messages, after the audio advertisement is played the calling and/or called party may be provided with an option of having further information sent to their telephone. The content of the SMS text message is related to the initial audio advertisement that was inserted in the voice communication stream. The text message may include a coupon or a link to a coupon. For example, after the audio advertisement is played to the caller, the caller may be asked “would you like to receive further information delivered to your telephone as a text message?” or “would you like to receive a coupon delivered to your telephone as a text message?” The caller can accept the offer of further information or coupon either by pressing a specified key on their telephone handset or speaking a specified keyword (for example, by pressing star (*) for “yes”, or saying “yes” to have the information delivered to the telephone). Similarly, the caller can decline the offer of further information either by pressing a specified key on their telephone handset or speaking a specified keyword (for example, by pressing star (#) for “yes”, or saying “no” to have the information delivered to the telephone). Alternatively, the offer could be declined by the user making no response after the expiry of a predefined timeout period from the offer of further information. Interactive voice response (IVR) implementation for processing voice responses and/or keypad inputs of the user are known in the art and will not be described herein. Any suitable IVR implementation may be used.

Typically, an IVR system comprises a voice gateway capable of interfacing with analog and digital telephony networks. The voice gateways also implement an IVR application for receiving and processing incoming calls. The IVR application allows a user to interact with the system via voice prompts responsive to the user's spoken response in the telephone receiver or the user input on the keypad of the user's computing device. The voice gateway is also connected to a communication subsystem which provides business logic, audio, and VoiceXML (VXML) for implementing the IVR application.

The SMS text message may contain any information that can be presented in plain text in accordance with the SMS specification. The SMS text message may comprise one or any combination of words, a URL (Uniform Resource Locator) to an Internet resource such as a web page, and/or one or more telephone of number(s). At least portions of the SMS text message may comprise executable or linking content that can be used by the user's telephone or voice client to perform an action. For example, if the SMS text message comprises a URL and the telephone or voice client has access to an Internet browser and Internet connection, clicking on the URL may directly cause the Internet browser to be launched (if not already active) and directed to a web page specified by the URL. If the SMS text message comprises a telephone number, clicking on the number may cause the telephone to dial the telephone number without the user having to key in the numeric information. Additionally, the text message may be sent from a specific telephone number or short code number for the purpose of enabling the recipient of the SMS text message to reply to the SMS text message and communicate directly from the advertiser or merchant, or to interact with the ACSP 502. As will be appreciated by persons of ordinary skill in the art, short codes or short numbers are special telephone numbers which are shorter than regular telephone numbers and which can be used to address SMS and MMS messages from mobile phones.

An example embodiment of a method of interacting with the ACSP 502 will now be described. A caller who has received a text message may reply to it, for example to a specific short code associated with the text message. The reply is delivered to the advertiser system 509 via the ACSP 502. This allows content to be delivered from the short code by the advertiser system 509. For example, the original text message sent by the advertiser system 509 to the user may include a question which the user can reply to. The user sends the reply to the question to the short code and the reply is delivered to the respective advertiser system 509. The advertiser associated with the respective advertiser system 509 may then act based on the user reply. For example, the original text message may ask the user if they would like to receive a coupon for a free or discounted product or service offering. If the user replies “yes” to the text message of the advertiser, the coupon is delivered via a further text message or a link (e.g., hyperlink) in the further text message to the coupon. Alternatively, the coupon could be sent via alternate medium such as an email via an email address of the user. The email address may be stored by the system 500 in the user database 160 or may be provided by the user during the interaction with the ACSP 502.

The question in the text message may be more detailed, for example, the question may ask the user to reply with the name of the specific product for which the user would like a coupon for a free or discount product or service offering. For example, the user may be asked if they would like to receive a coupon for a free can of pop or soda from a specific manufacturer or merchant. The text message may instruct the user that, if he or she wants to receive the coupon, to provide the name of specific brand of pop or soda from a predefined lists of pop or soda in the original text message. The ACSP 502 then receives the response from the user, selects the appropriate coupon based on the reply text message received from the user, and then sends the user a hyperlink or URL to the coupon on the advertiser's or manufacturer's website. The user may then invoke the hyperlink to launch the Internet browser 404 on the computing device 301 to display the web page pointed to by the hyperlink or URL where the user can print and/or download the coupon to the computing device 301. In other embodiments, rather than requiring the user to select one of a number of specifically named products, the user may be requested to reply with one of a number of predefined descriptors such as a type of pop or soda (i.e., ginger ale, orange, cream soda, etc.) or videogame (e.g., driving, strategy, war, etc.). The original text message from the advertiser or merchant typically includes the name of the associated merchant or vendor.

It will be appreciated that other types of extended information may also be provided, and that the present disclosure is not limited to providing coupons. The extended information may be a map or hyperlink to a map of the advertiser or merchant's location (or closest location to the user based on location information), directions or a link to directions to the advertiser or merchant's location (or closest location to the user based on location information), further details about the goods or services offered by the advertiser or merchant, further details about a promotion associated with the content of the original text message or other promotion(s), or any other information whether it is provided directed in the form of the reply to the text message or a link provided in the reply. Furthermore, when the user is given a choice of the “extended information” to be received, whether it is a coupon or other extended information, the contextual character of the reply provided by the user does not matter so long the ACSP 502 may use the user reply to select the appropriate extended information to send to the user. The user reply may allow the user to selected the communication medium for deliver of the extended information, the type of extended information (e.g. map, directions, coupon, further details about the advertiser or merchant, further details about a promotion, etc.), and/or the specific extended information to be received, i.e. coupon for product X or product type X.

### MMS (Multimedia Messaging System) Message Advertisements

If the user's telephone or voice client supports MMS messages, after the audio advertisement is played the calling and/or called party may be provided with an option of having further information sent to their telephone as an MMS text message. As will be appreciated by persons of ordinary skill in the art, the difference between an SMS and MMS message is that an MMS message may contain graphics, audio, rich text, and/or video content in addition to plain text.

The content of the MMS text message is related to the initial audio advertisement that was inserted in the voice communication stream. The MMS message may include a coupon or a link to a coupon. For example, after the audio advertisement is played to the caller, the caller may be asked “would you like to receive further information delivered to your telephone as a text message?” or “would you like to receive a coupon delivered to your telephone as a text message?” The caller can accept the offer of further information or coupon either by pressing a specified key on their telephone handset or speaking a specified keyword (for example, by pressing star (*) for “yes”, or saying “yes” to have the information delivered to the telephone). Similarly, the caller can decline the offer of further information either by pressing a specified key on their telephone handset or speaking a specified keyword (for example, by pressing star (#) for “yes”, or saying “no” to have the information delivered to the telephone). Alternatively, the offer could be declined by the user making no response after the expiry of a predefined timeout period from the offer of further information. Interactive voice response (IVR) implementation for processing voice responses and/or keypad inputs of the user are known in the art and will not be described herein

The MMS text message may contain one or any combination of plain text, rich text, graphics, audio, and video content in accordance with MMS the specification. The MMS text message may comprise one or any combination of words, a URL (Uniform Resource Locator) to an Internet resource such as a web page, and/or one or more telephone of number(s). At least portions of the MMS text message may comprise executable or linking content that can be used by the user's telephone or voice client to perform an action. For example, if the MMS text message comprises a URL and the telephone or voice client has access to an Internet browser and Internet connection, clicking on the URL may directly cause the Internet browser to be launched (if not already active) and directed to a web page specified by the URL. If the MMS text message comprises a telephone number, clicking on the number may cause the telephone to dial the telephone number without the user having to key in the numeric information. Additionally, the text message may be sent from a specific telephone number or short code number for the purpose of enabling the recipient of the MMS text message to reply to the MMS text message and communicate directly from the advertiser or merchant, or to interact with the ACSP 502 to receive extended information as described above.

### Instant Messaging (IM) Message Advertisements

If the user is connecting to the system 500 via an IM client or VoIM client 130, after the audio advertisement is played the user may be provided with an option of having further information sent to the IM client or VoIM client 130 as IM message. The further or extended information may comprise a coupon or other extended information, or a link to a coupon or other extended information as described above. While in many instances, a user may connect to the system 500 for a voice call using a VoIM client 130, a user may connect to the system 500 using a non-voice IM client or a VoIM client 130 for text messaging only and connect to the system 500 for voice calls using a landline/PSTN telephone 107, mobile telephone 202 or VoIM softphone or VoIP phone 128. Thus, the user may have a VoIM client 130 but choose to connect to the system 500 for voice calls using a different connection type.

If the user is connected to the system 500 using an IM client or VoIM client 130 (as described above, the various user connections to the system 500 are determined by the system 500 when determining which advertising component(s) will be delivered to the user), an IM message comprising a text advertisement or multimedia advertisement may be delivered to the respective as instant messages within the IM client or VoIM client 130.

The IM message comprising the text advertisement or multimedia advertisement may delivered as a new conversation between the user and the advertiser system 509 or its respective advertiser, the user and the system 500 or system administrator, or may be inserted into the instant message communication stream of an IM conversation or chat between IM users. In such embodiments, typically the text advertisement or multimedia advertisement is appended to an IM message, typically as a footer to the IM message being sent from one user to another. Alternatively, the IM advertisement may appear within the conversation as a new member of the IM conversation or chat.

### Email Advertisements

If the user is connecting to the system 500 via a VoIP softphone 128 which connections to the system via a computer 101, a text advertisement or multimedia advertisement may be sent to the user via an email message to an email address of the user. The email address may be stored by the system 500 in the user database 160.

### “Click to Communicate” Advertisements

Using “click to communicate” advertisements, at the end of the voice call callers are presented with an option to be connected with the advertiser or merchant whose audio advertisement was inserted and played prior to the call being connected. This applies to anyone who was presented an audio advertisement, i.e. to one or both of the calling and called parties depending on whether an audio advertisement was played. In some embodiments, the caller need only stay on the line and the call will be automatically connected to the advertiser or merchant, for example, after a predetermined period of time. The call is transferred and connected to a representative (i.e., a voice call with an individual) or an IVR system of the advertiser or merchant. The destination of the call transfer is configured by the advertiser and can be a telephone number of a landline PSTN telephone 107, a VoIP phone 128, a mobile telephone 202, a VoIP SIP URI (Session Initiation Protocol Uniform Resource Indicator) or VoIM (Voice over Instant Messenger) address. In some embodiments, routing rules based on the availability of the advertiser or merchant (for example, based on the presence information or status of the merchant or advertiser), the time of day, and whether the primary contact point is occupied or not.

Alternatively, the user may be connected to the advertiser or merchant using instant messaging. The user may be connected to the advertiser or merchant using instant messaging regardless of the type of connection used for conducting the voice call. In other words, the user need not use a VoIM client 130 for the voice communication to connect to the advertiser or merchant using instant messaging. Whether the user is offered to connect to advertiser or merchant using voice communication or instant messaging communications depends on the advertiser preferences stored by the system 500 in the user database 160 and the technical capabilities of the user, i.e. whether the user's computing device 301 has an IM client or VoIM client 130. If the user has an IM client or VoIM client 130 on the computing device 301 and the advertiser preferences of the advertising campaign specify using instant messaging communications, the SIP proxy server 410 establishes an SIP session between the user and advertiser system 509 and connects the IM client or VoIM client 130 on the user's computing device 301 with that of the advertiser or merchant.

As described above, advertiser computer systems 509 of participating advertisers are typically connected to the dynamic contact engine 510 and agree to share presence information with the communication mediation subsystem 150. This allows presence information relating to the advertiser systems 509 to be shared with the ACSP 502 and may be used in determining whether to allow click to communicate advisements and/or how to direct the call transfer, i.e., to a personal representative or an IVR system using voice communications or to an IM client using instant messaging. Presence information relating to the advertiser system 509 may be determined using any suitable method as described above.

Factors used in determining whether to allow click to communicate advisements and/or how to direct the call transfer may include (1) the time of day (for example, to determine if it is outside of business hours), (2) day of week, (3) whether the contact point (i.e. the telephone line, IVR system, or IM client) is busy or “occupied”, (4) the technical capabilities of the user's computing device 301, and (5) the advertiser preference voice communications and IM communications, among other factors. Advertisers and merchants may the same party, or alternatively the advertiser may be a third party such as an advertising agency which acts on behalf of a direct merchant or vendor of goods or services. Typically, where the advertiser is a third party the click to communicate advertisements connect the caller to the actual merchant or vendor of goods or services.

### Self-Service Advertiser Portal

The ACSP 502 provides a self-service advertiser portal 508 for uploading advertisements to the targeted advertising system 500. Advertisers create and upload their audio recordings, SMS advertisements, and/or MMS advertisements to the database 506 of the ACSP 502. Typically, advertising campaigns are created by an individual advertiser based on parameters and preferences defined by the advertiser and stored in the database 506. In one embodiment, the parameters comprise how the advertisement is distributed and the maximum amount of money that can be spent on the advertisements and/or advertising campaigns. The ACSP 502 maintains a database 506 of campaign statistics and information relating to the advertiser's advertisements and advertising campaign. The campaign statistics database 506 may comprise the number of callers to whom audio advertisements were played, the date and time advertisements were played, the number and destination of SMS and MMS text messages which were sent to callers (which typically requiring the callers to accept or request the SMS/MMS message, as noted above), the date and time SMS/MMS text messages were sent, the number of calls which were transferred using the click to communicate advertisements to the advertiser or merchant's destination telephone number, SIP URI or VoIM address, and the date and time of the transfer. Other information may also be included in the database 506.

In terms of how the advertisement is distributed, the advertiser selects from one or more demographic categories of demographic information to determine how the advertisement will be played. The demographic information may comprise: geographic location, stated preferences, learned preferences and any other demographic information which can be attributed to the individual calling party and/or one or more called parties. The demographic information is chosen to aid in the targeting of advertisements to callers who will have a greater likelihood of being interested in the product, service or information being advertised.

In terms of the maximum amount of money that can be spent on the advertisements and/or advertising campaigns, one or more payment thresholds may applied. Each of the above-described types of advertisement may have a fee associated with each instance the advertisement is played, displayed, or accessed by the calling party or called parties. For example, the audio advertisement, SMS messages, MMS messages, and click to communicate transfers may have an associated fee which is charged to the advertiser or merchant for each caller (i.e. calling party or called parties) to whom an advertisement is played, an SMS message is sent, an MMS message is sent, or click to communicate transfer is made. The fee for each of these advertisement types may be the same or different.

In some embodiments, three payment thresholds are used in calculating the maximum cost: a maximum cost per advertisement, a maximum cost per day, and a maximum cost per campaign (determined by its predefined duration, i.e., the weeks or months of the campaign). In some embodiments, if the advertising campaign exists any of these payment thresholds, advertisements are discontinued at least temporarily. Depending on the payment threshold which is exceeded, select types of advertisement may be discontinued if the exceed maximum cost per advertisement. If the daily cost payment threshold is exceeded, advertisements are discontinued until the next business day. If the cost per campaign payment threshold is exceeded, advertisements are discontinued indefinitely until the advertising campaign ends or the maximum cost per campaign is increased.

In one embodiment, the audio advertisements comprise an audio recording having a minimum length ten (10) seconds. The audio recordings are uploaded to the database 506 using the self-service advertiser portal 508 and will be played to callers (i.e., the calling parties and/or the one or more called parties) selected in accordance with the demographic information chosen by the advertiser. Typically, advertisers create the audio recordings outside of the targeted advertising system 500 and upload the recordings to the database 506 using the self-service advertiser portal 508, for example, via an Internet browser. In addition to the audio recording which comprises the audio advertisement to be played to callers, a second audio recording of the name of the merchant or vendor business may be uploaded to the database 506. The second audio recording may be played during a click to communicate call transfer to the advertiser (i.e., merchant or vendor). Both audio recording files may be created in a recording studio, with a variety of commercially available audio recording programs available for the Windows™, Linux™ or Apple™/Macintosh™ based personal computers, or any other suitable means.

In addition to the two audio recordings, advertisements in the form of SMS messages and MMS messages are created by advertisers and uploaded to the database 506 using the self-service advertiser portal 508, for example, via an Internet browser.

The self-service advertiser portal 508 also allows advertisers to view real-time statistics about their advertising campaign. Typically, advertisers log into the ACSP 502 using the self-service advertiser portal 508 from a computer 101 using a unique username or other identifier and password/passcode or personal identification number (PIN), for example, via an Internet browser or Java™ application. The advertiser may the view the statistics and information regarding the advertising campaign, and optionally modify the advertising campaign parameters such as the selected demographic information, the duration of the advertising campaign, and the payment thresholds.

It will be appreciated that the communication system 500 shown in FIG. 5 is illustrative of a suitable communication system for implementing the method of targeted advertising in the present disclosure, and that other configurations are possible.

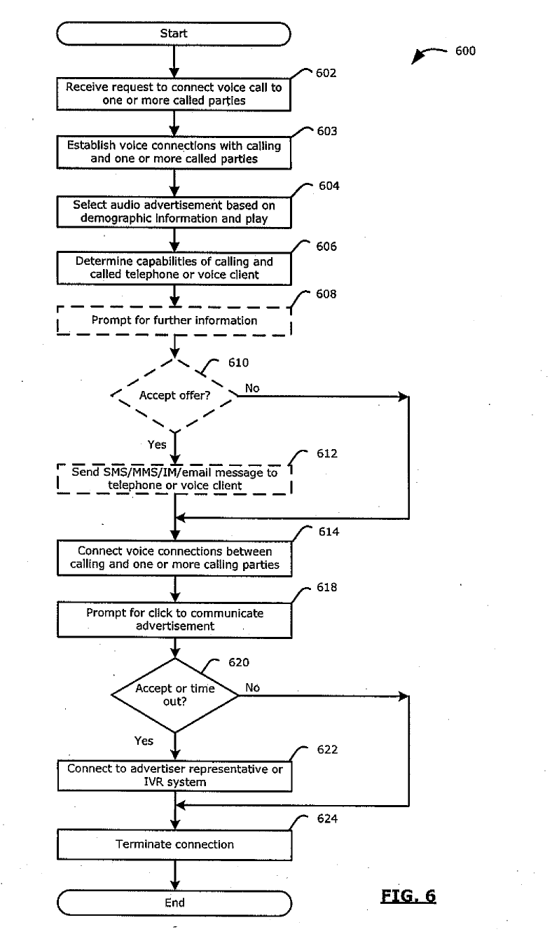

Referring now to FIG. 6, example operations 600 for targeted advertising in a communication system for mediating voice and text communications in accordance with one embodiment of the present disclosure will be described. In a first step 602, a request to connect a voice call to one or more called parties is received by the communication mediation subsystem 150. The requested voice call connection may be a call back to a call back telephone or voice client via a call back number or other identifier, a call-in from a call-in telephone or voice client via a call-in number or other identifier, or a direct call from a telephone or voice client.

The request may be to initiate the call to a contact in a contact list or address book based on user input selecting a contact in the contact list or may be provided prior to call time via user input. In some embodiments, the system 150 may determine which telephone number or other identifier of a contact is to be used from one or more identifiers, for example, using presence information of the contact. The selected identifier may be a telephone number (e.g., a landline telephone number, a mobile telephone number or a VoIP telephone number______, an instant messaging (IM) address, and a session initiation protocol uniform resource indicator (SIP URI). If the contact identifier corresponds to a landline or mobile telephone, the destination phone number may be converted into the E.164 international dialling format. If the originating communication device is a mobile telephone, the conversion/formatting may be based on the home location of the mobile telephone and the current location of the mobile telephone.

If the contact identifier corresponds to an IM address in a VoIM network, the network server 154 may determine the availability of the contact to receive a voice call by checking presence information corresponding to the IM address on the dynamic presence engine 510 (FIG. 5). The presence information may be transmitted to the originating communication device from which the voice call originates or a separate computing device 301 for accessing the GUI and transmitting connection instructions to the communication system 100. If the IM contact is not online or if their presence information indicates they are otherwise not available, the system 150 may notify the user (calling party) of the “negative” presence information and be configured not to place the voice call. If the IM contact is online and/or their presence information indicates they are available to take a call, the voice call proceeds. Alternatively, the system 150 may not check the presence information before proceeding because, for example, the IM contact has not agreed to share presence information. This may also occur because presence information about called parties may not always be accurate, for example, where it is based on user provided information or rules for updating presence information. In such cases, presence information may be provided to the user within the GUI but not used in decision making by the system 150. Alternatively, the system 150 may notify the user of the “negative” presence information and provide the user with an option to choose whether or not to proceed with the voice call based on the presence information.

### “Direct Call ” Voice Connection

If the user has chosen a direct call from the originating communication device (i.e., a telephone with voice and data capabilities or computer with a voice client) as the connection type for the voice call, connection instructions are transmitted from the originating communication device to the network server 154. The network server 154 forwards these instructions to the local access VoIP gateway 152.

The connection instructions specify that an inbound call will be received from the originating communication device (i.e., telephone or voice client) at the local gateway number of the local access VoIP gateway 152. The instructions also include the telephone number of the originating communication device so that the VoIP gateway 152 can identify the inbound call when it is received. The instructions also include the contact identifier of the called party, instructions for the VoIP gateway 152 to initiate an outbound call (i.e., establish a voice connection) to the contact identifier when the inbound call from the originating communication device is received, and instructions to bridge the inbound and outbound calls after advertisement insertion thereby connecting the voice call.

The originating communication device is instructed to initiate the inbound call to the local access VoIP gateway 152 at the local access gateway number. The local access gateway number is determined by the network server 154 based on the location of the originating communication device based on internal algorithms and transmitted to the originating communication device by the network server 154.

### “Call Back” Voice Connection

If the user has chosen to use a call back to the originating communication device (i.e., the call back telephone) as the connection type for the voice call, connection instructions are transmitted from the computer 101 or other device accessing the GUI to the network server 154. The network server 154 forwards these instructions to the local access VoIP gateway 152.

The instructions instruct a local VoIP gateway 152 to initiate an outbound call to the originating communication device at the call back number or other identifier. The instructions include the contact identifier of the called party, the call back number of the originating communication device, instructions to initiate an outbound call to the contact identifier when the outbound call to the originating communication device is connected, and instructions to bridge the outbound calls to the originating communication device (i.e., call back telephone or voice client) and contact identifier after advertisement insertion thereby connecting the voice call.

The call back telephone number may be specified in user preference stored in a user profile stored by the network server 154 in the user database, or may be provided by the user at call time. The call back telephone number may be any telephone number, for example, the call back telephone number may be a telephone phone associated with a mobile communication device 202, a landline/PSTN phone 107 or VoIP phone 128. Alternatively, another identifier such as an IM address for a VoIM client 130 or an SIP URI for a VoIP softphone or VoIP phone 128 may be used.

The VoIP gateway 152 initiates the outbound call to the calling party at the specified call back telephone number or other identifier. Once the call back is answered by the user at the call back telephone number or other identifier, the call is connected to the VoIP gateway 152 and the network interconnect softswitch 304 via the VoIP gateway 152. The call is now in a standard format which allows for connection to any of the networks supported by the softswitch 304/SIP Softswitch/Media Gateway 412.

### “Call-In” Voice Connection

If the user has chosen to use a call-in from the originating communication device as the connection type for the voice call, connection instructions are transmitted from the originating communication device to the network server 154. The network server 154 forwards these instructions to the local access VoIP gateway 152.

The connection instructions instruct a local VoIP gateway 152 that an inbound call will be received from the originating communication device (i.e., call-in telephone or voice client) at the local gateway number of the local access VoIP gateway 152. The instructions include the call-in telephone number or other identifier of the call-in telephone or voice client so that the VoIP gateway 152 can identify the inbound call when it is received. The instructions also include the contact identifier of the called party, instructions for the VoIP gateway 152 to initiate an outbound call (i.e., establish a voice connection) to the contact identifier when the inbound call from the originating communication device is received, and instructions to bridge the inbound and outbound calls after advertisement insertion thereby connecting the voice call.

The call-in telephone number may be any telephone number in the user database, or may be provided by the user at call time. The call-in telephone number may be any telephone number, for example, the call-in telephone number may be a telephone phone associated with a mobile communication device 202, a landline/PSTN phone 107 or VoIP phone 128. Alternatively, another identifier such as an IM address for a VoIM client 130 or an SIP URI for a VoIP softphone or VoIP phone 128 may be used.

The calling party must then place the call from the call-in telephone or voice client to the local access gateway number to initiate the inbound call to a local access VoIP gateway 152. The local access gateway number is determined by the network server 154 based on the location of call-in telephone based on internal algorithms. The local access gateway number may be displayed/presented within the GUI of the computer 101 or other device accessing the system 150, or transmitted to the computer 101 or other device, for example by email or SMS.

Once the calling party is connected to local access VoIP gateway 152, it uses least cost routing to determine an optimal route (i.e., which route is the most cost effective, the most reliable, or which has the “optimal” combination of cost and reliability ratings in accordance with various cost and quality parameters and calculated using internal algorithms) for routing the call to the contact identifier. The VoIP gateway 152 initiates the outbound call to the contact identifier selected by the calling party via the determined least cost route.

If the called party is using a VoIP phone or SIP client, once the calling party is connected to local access VoIP gateway 152, the network server 154 establishes an SIP session between the originating communication device and the VoIP phone 128 corresponding to the destination SIP URI. The network interconnect softswitch 304 (FIG. 3) performs signalling and protocol conversion to connect the originating communication device and SIP-based VoIP phone 128. The call is now connected to the gateway in a format which allows for connection to any of the networks supported by the VoIP gateway 152.

If the called party is using a VoIM client 130, the network server 154 determines which IM network the call is destined for, typically by analyzing the destination IM address. For example, if the destination IM address contains “msn” or “hotmail” this indicates the Microsoft Messenger™ network. Similarly, if the address contains “Yahoo” this is for the Yahoo! Messenger™ network, or if the address contains “Gmail” or “googlemail” this indicates the Google Talk™ network. A list of domain names associated with the various IM networks is typically maintained by the network server 154. Other methods of determining the destination IM network may be used. Once the calling party is connected to local access VoIP gateway 152, the network server 154 establishes an SIP session between the originating communication device and the VoIM client 130 over the determined IM network. The SIP session is established between the SIP Softswitch/Media Gateway 412 and the IM/VoIP gateway 416.

Techniques for connecting a voice call between a calling party and one or more called parties are further described in co-pending U.S. and PCT patent applications entitled “A METHOD AND SYSTEM FOR SMART ROUTE DIALLING TO A CONTACT IDENTIFIER USING A TELEPHONE”, published as U.S. 2007/0238472 A1 and WO 2007/112594 A1 respectively on Oct. 11, 2007. The entire contents of both documents being incorporated by reference herein.

Next, in step 603 a voice connection/communication path is established between the originating communication device from which the voice call will originate (i.e., the call back telephone or voice client, call-in telephone or voice client, or direct call telephone or voice client) and the VoIP gateway 152, and between the called party and the VoIP gateway 152.

### Advertisement Insertion

Next, in step 604 prior to bridging the voice call being the calling party and the called parties an audio advertisement is selected based on demographic information about the calling party and/or called parties in accordance with predetermined parameters stored by the ACSP 502. Whether the audio advertisement is played to the calling party, the called parties or both depends on advertiser preferences. Alternatively, if desired the voice connections may be bridged prior to the audio advertisement being played. Once the voice connections are bridged, the audio advertisement is played so that both the calling and called parties hear the same audio advertisement. As described above in connection with the targeted advertising system 500, the demographic information chosen may be based on the calling party, called party or a combination of the calling and called parties. The selected audio advertisement is then played to the calling party and/or called parties, depending on the predetermined parameters. The audio advertisement played to calling party and called parties may be the same or different. This depends on the selected demographic information and predetermined parameters.

Next, in step 606 the technical capabilities of the telephone or voice client of the calling and/or called parties is determined. Whether the technical capabilities are determined for the calling party, the called parties or both depends on advertiser preferences. This step may not be performed in all embodiments. For example, this determination may have been made previously and be stored by the ACSP 502. In other embodiments, this step is not performed because any unsupported advertising components inserted into the communication stream will be ignored by the receiving telephone or voice client. The system then selects a contact identifier for an SMS message, MMS message, IM message, or email message based on the determined technical capabilities.

In some embodiments, determining the technical capabilities comprises determining whether the communication device is a telephone or voice client. If the communication device is a telephone, it is further determined whether the telephone is a landline/PSTN telephone 107, VoIP phone 128 or a mobile telephone 202, and if the telephone is a mobile telephone 202 whether it can accept SMS or MMS messages. If the communication device is a computing device 301 running a voice client, it is further determined if the voice client is a VoIM client 130 or VoIP softphone 128.

If the communication device is a telephone which is not capable of receiving an SMS or MMS message or is a VoIP softphone 128, the system may select from the user database an IM address, a mobile telephone number of a mobile telephone which is capable of receiving an SMS or MMS message, or an email address. This step is optional. In other embodiments, if the communication device is telephone which is not capable of receiving an SMS or MMS message or is a VoIP softphone 128, no contact identifier is selected the operations 600 proceed to step 614 and may omit steps 618-622. The selecting may involve using stored information concerning the technical capabilities of the device associated with the IM adders, telephone number, or email address. The information concerning the technical capabilities of the device may have been previously provided by the user or previously determined by the system 500 and stored in the user database.

The contact identifier for the SMS message, MMS message, IM message, or email message may be selected based on advertiser preferences in addition to, or instead of, the technical capabilities of the communication device of the calling and/or called parties is determined. A selection based on advertiser preferences may be made independent of the technical capabilities of the communication device of the calling and/or called parties. For example, an advertiser may specify that an SMS message, MMS message, IM message, or email message is to be used if such a contact identifier is available for the calling and/or called parties. An advertiser may specify a priority order in which an SMS message, MMS message, IM message, or email message should be sent, depending on the available contact identifiers and possibly the technical capabilities of the associated device.

Next, in step 608 the calling party and/or called parties are prompted to accept an offer for extended information. Whether the offer is sent to the calling party, the called parties or both depends on advertiser preferences. This step may not be performed in all embodiments, in particular if the technical capabilities of the telephone or voice client of the calling and/or called parties do not permit the receiving of extended information or the offer for extended information. For example, if it is determined that the receiving telephone cannot accept SMS or MMS messages or that voice client is VoIP softphone 128, the operations 600 may proceed to step 614. If the offer is not accepted within a predetermined period of time, a time out occurs and the operations 600 proceed to step 614. In other embodiments this step may occur at another stage in the operations 600, for example after the voice call is connected between the calling and called parties. Moreover, in other embodiments the user may not be prompted to accept an offer for extended information in which case the extended information is sent without regard to the user's wishes or preferences. In other embodiments, a stored preference(s) regarding further or extended information, for example in the user database 160, may be used instead of presenting an offer for extended information so that the user need not be prompted for input regarding whether they would like to receive the further or extended information at each voice call.

If the offer is accepted within a predetermined period of time, the operations 600 proceed to step 612 where an SMS message, MMS message, IM message, or email message is sent to the calling and/or called parties using the contact identifier selected based on the technical capabilities of the originating communication device (telephone or voice client) of the calling and/or called parties is determined and/or advertiser preferences.

Next, in step 614 after the audio advertisement has been played to the calling and/or called parties, the VoIP gateway 152 connects the voice call between the calling party and one or more called parties at the specified contact identifiers. This step involves bridging the voice connection between the originating communication device and the VoIP gateway 152, and the voice connection between the VoIP gateway and the telephone or voice client of the called parties.

Once a voice connection is established between the originating communication device and the VoIP gateway 152, and between the VoIP gateway 152 and the called parties, the voice connections are in a format which allows for connection to any of the networks/voice connections supported by the VoIP gateway 152. The connection between the originating communication device and the VoIP gateway 152 is bridged with the outbound call from the local access VoIP gateway 152 to the contact identifier using the network interconnect softswitch 304. The network interconnect softswitch 304 of the network server 154 bridges the calls voice connections whereas the VoIP gateway 152 establishes the individual voice calls/connections.

If the called party is using a VoIM client 130, the SIP session is established between the SIP Softswitch/Media Gateway 412 and the IM/VoIP gateway 416. The IM/VoIP gateway 416 connects to the VoIM client 130. The PSTN access gateway 408 connects with the Softswitch/Media Gateway. The SIP Softswitch/Media Gateway 412 makes the connection between the SIP Softswitch/Media Gateway 412 and the IM/VoIP gateway 416 which creates the chain from end-to-end. The network interconnect softswitch 304 (FIG. 3) performs signalling and protocol conversion to connect the originating communication device and VoIM client 130 over the IM network (via the Softswitch/Media Gateway 412 (FIG. 4) and IM/VoIP gateway 416 (FIG. 4)) network. The voice connection between the originating communication device and the local access VoIP gateway 152 is bridged with the destination VoIM client 130 via the local access VoIP gateway 152.

The IM/VoIP gateway 416 transcodes SIP-compatible voice data packets from the VoIP gateway 152 into voice data packets that are compatible with the respective VoIM networks in accordance with the networks' respective encodation protocol. After transcoding the voice data packets into a format that is compatible with the respective VoIM network, the transcoded voice data packets can be transmitted to the respective VoIM network The IM/VoIP gateway 416 also transcodes voice data packets received from the respective VoIM networks into SIP-compatible voice data packets for transmission to the VoIP gateway 152 and from the VoIP gateway 152 to the calling party via the originating communication device.

Next, in step 616 the voice call is automatically terminated by the VoIP gateway 152 when one party to hangs up or ends the call. When this occurs, the connection(s) of any remaining parties to the call are not automatically disconnected. If the telephone or voice client of any parties to the voice call is still connected to the VoIP gateway 152 (i.e., because they have not hung up the telephone or terminated the voice client connection), the calling party and/or called parties are prompted to accept an offer for a “click to communicate” advertisement.

Next, in step 620 it is determined if the calling party and/or called parties have accepted the offer to connect to a “click to communicate advertisement”. If the offer is accepted, the operations 600 proceed to step 622 where the calling party and/or called parties are connected to an advertiser's representative (i.e., a voice call with an individual) or an IVR system of the advertiser or merchant. If the offer is not accepted, the operations 600 end. In some embodiments, the offer may be automatically accepted after a if no negative response is received during the predetermined period of time (failure to hang up/terminate the voice connection being deemed acceptance) period. The user may accept using keypad input of other input of their telephone or voice client, and/or may accept using a voice response if an IVR system is used.

Alternatively, rather than connecting the called parties are connected to an advertiser's representative or an IVR system of the advertiser or merchant, the calling party and/or called parties are connected to the advertiser or merchant using instant messaging. The callers may be connected to the advertiser or merchant using instant messaging regardless of the type of connection used for conducting the voice call. In other words, the callers need not use a VoIM client 130 for the voice communication to connect to the advertiser or merchant using instant messaging. Whether the callers are offered to connect to advertiser or merchant using voice communication or instant messaging communications depends on the advertiser preferences stored by the system 500 in the database 506 and the technical capabilities of the callers, i.e. whether the callers' computing device 301 has an IM client or VoIM client 130. If the callers have an IM client or VoIM client 130 on the computing device 301 and the advertiser preferences of the advertising campaign specify using instant messaging communications, the SIP proxy server 410 establishes an SIP session between the respective caller and advertiser system 509 and connects the IM client or VoIM client 130 on the caller's computing device 301 with that of the advertiser or merchant.

If the offer is declined, for example, if the calling party or called parties disconnect the telephone or voice client, the operations 600 proceed to step 624 where the connection is terminated and the operations 600 end. In some embodiments, an intermediate IVR system may be used prior to connecting to the advertiser, for example, to accept keypad or voice responses whether to accept the offer for the click to communicate advertisement.

While the operations 600 have been described as occurring in a particular order, it will be appreciated to persons skilled in the art that some of the steps may be performed in a different order provided that the result of the changed order of any given step will not prevent or impair the occurrence of subsequent steps. For example, the audio advertisement may be played at any time during the operations, i.e., before, during or after the voice call has been connected. Furthermore, some of the steps described above may be combined in other embodiments, and some of the steps described above may be separated into a number of sub-steps in other embodiments.

The manner in which voice, email, SMS, MMS, and instant messaging communications to a contact in the dynamic contact list are initiated and connected is outside the scope of the present disclosure and will not be described in detail herein. A suitable method of initiating a voice call via a contact identifier comprising one of a landline telephone number, a mobile telephone number, an instant messaging (IM) address, and a session initiation protocol uniform resource indicator (SIP URI), is described in co-pending U.S. patent application Ser. No. 11/697,066 and PCT patent application no. PCT/CA2007/000592 entitled “A METHOD AND SYSTEM FOR SMART ROUTE DIALLING TO A CONTACT IDENTIFIER USING A TELEPHONE”, published as U.S. 2007/0238472 A1 and WO 2007/112594 A1 respectively on Oct. 11, 2007. The entire contents of both documents being incorporated by reference herein.

Voice calls between a calling party and one or more called parties may be connected between callers (i.e., calling and called parties) using the same or different voice communication protocols. The calling and one or more called parties may use a landline telephone, a mobile telephone, a Voice over Instant Messaging (VoIM) client, or Voice over Internet Protocol (VoIP) phone or client. The voice call may be connected without requiring the calling party to choose the contact identifier/contact information to be used for connecting to the one or more called parties, and without the calling party having to known or selected the communication protocol(s) and connections(s) to be used for connecting the voice call. In some embodiments, this may be achieved from a common interface which requires the user to merely select the parties to be called. The processing and connections required to establish the voice call being performed and established by the interface in a manner which is invisible to the user.

For a calling party to connect to the communication system 100, a user requires a computing device for accessing a graphical user interface (GUI) for transmitting connection instructions to the communication system 100 (e.g., to the network server 154 and/or VoIP gateway 152) typically via an Internet connection, and a voice-enabled communication device such as a telephone or voice client for connecting the voice call. The computing device and communication device may be the same or different devices. The GUI may be provided by a mobile communication device 202 having both voice and data capabilities (sometimes referred to as a smart phone) or a computer. The telephone may be a landline telephone (such as a public switched telephone network (PSTN) phone or VoIP phone) or mobile telephone. The voice client may be a VoIP softphone or VoIM client on a computer.

In at least some embodiments, the GUI allows users to view a contact list comprising electronic contact records each comprising contact information details which comprise at least a contact name and a contact identifier comprising one or more of: a landline telephone number, a mobile telephone number, an instant messaging (IM) address, and a session initiation protocol uniform resource indicator (SIP URI). Other information such as business name, address and other contact information may also be in the contact records. The contact list may be stored locally on the computer 101 or mobile communication device 202, stored remotely on a network server, or may be a consolidated contact list dynamically generated from the local contact list and the contact list on the network server. Rules may be applied to select contact records from the local and network contact lists when dynamically generating the dynamic contact list.

A calling party may select a contact identifier and instruct the communication system 100 to connect a voice call without the user having to know how to connect the voice call for the selected contact identifier. In some embodiments, a calling party may select a contact record and instruct the communication system 100 to connect a voice call without the user having to know which contact identifier should be used. In such embodiments, the communication system 100 may select the appropriate contact identifiers based on presence information associated with the contact identifiers in a contact record of the contact list.

A voice call may be connected to a called party using one of several different methods. In accordance with the first method, a smart phone or mobile communication device 202 having both voice and data capabilities, or a computer having a VoIP softphone or VoIM client for establishing the voice call is used. Using this method, the communication device on which the GUI is accessed is used to connect the voice call. It should be appreciated that even though the mobile communication device and computer could be used to connect the voice call, the user may still choose to use one of the alternative methods described below. The mobile communication device or voice client is used to call a VoIP gateway at a local access gateway number. The local access gateway number is typically a local or toll free telephone number having no associated charge. This may bypass costs associated with dialling national, mobile and/or international calls directly at the rates that would be normally charged. This is commonly referred to as a “toll bypass”.

The VoIP gateway then routes the voice call to the called party at the contact identifier. Depending on the type of connection associated with the contact identifier, i.e. a landline telephone, a mobile telephone, a Voice over Instant Messaging (VoIM) client, or Voice over Internet Protocol (VoIP) phone or client, the voice call is routed over the respective, PSTN, wireless network, VoIP network, or VoIM network. If the contact identifier corresponds to a landline or mobile telephone, least cost routing is used to determine and route the voice call in a cost effective manner. This occurs without the user having to know the possible connection options for connecting the call or the associated costs. If the contact identifier corresponds to a landline or mobile telephone, the destination phone number may be converted into the E.164 international dialling format based on the home location of the mobile communication device and the current location of the mobile communication device. If SIP URIs or IM identifiers/addresses are called, the VoIP gateway routes the calls from the originating voice communication device to the respective VoIP or VoIM end points, allowing the connection of a voice call originating on a conventional telephony network (i.e., such as a cellular network) with an SIP-enabled VoIP phone or client or VoIM client. Conventionally, voice calls cannot be connected between these types of networks. The protocol and signalling conversion provided by the VoIP gateway allows such connections to be made.

In accordance with the second method, a call back number and telephone is used. A call back number may be used, for example, because the user has no mobile telephone or the user's mobile telephone lacks the functionality to provide the GUI (i.e., it has no data functionality, lacks a browser, or lacks Java™ support—in this case the GUI is accessed by a computer) or because using the call back number may result in a lower cost than if the voice call originated from the mobile phone. A call back number may also be used because, if the GUI is accessed by a computer, the computer lacks the functionality to provide a VoIP softphone or VoIM client. The VoIP gateway calls the user's call back telephone at a designated call back number. This may be any telephone number provided by the user. This may be a stored setting or option, or may be provided by the user prior to the call being made. If the user accessed the GUI via their mobile telephone, they may choose their mobile telephone number as the call back number, for example, because it may result in a lower cost. Once the call is answered on the call back telephone, the call back telephone is connected to the VoIP gateway. The VoIP gateway then routes the voice call to the called party at the contact identifier, as described above.

In accordance with the third method, a call-in number and telephone is used. A call-in telephone number may be used, for example, because the user has no mobile telephone or the user's mobile telephone lacks the functionality to provide the GUI (i.e., it has no data functionality, lacks a browser, or lacks Java™ support—in this case the GUI is accessed by a computer), or because using the call-in telephone may result in a lower cost than if the voice call originated from the mobile phone. A call-in number may also be used because, if the GUI is accessed by a computer, the computer lacks the functionality to provide a VoIP softphone or VoIM client. The call-in telephone number may be any telephone number provided by the user. This may be a stored setting or option, or may be provided by the user prior to the call being made. The calling party uses the call-in telephone to call a VoIP gateway at a local access gateway number. The VoIP gateway has been instructed that an inbound call will be received from the call-in telephone number. When the inbound call from the call-in phone is received by the VoIP gateway, it routes the voice call to the called party at the contact identifier, as described above.

It will be appreciated to persons skilled in the art that various alterations, modifications and variations to the embodiments described herein may be effected. For example, while voice calls have been discussed primarily in the context of a caller or calling party and a single called party at the destination of the voice call, it will be appreciated that the teachings of the present disclosure may be adapted for use in conference calls with two or more called parties. Moreover, the contact identifier (be it a telephone number, an SIP URI, or an IM address) may be provided via respective user input on the telephone or voice client rather than being selected from a contact list as described in the example operations.

The foregoing detailed description of example embodiments of the present disclosure does not limit the implementation of the application to any particular computer programming language. The present disclosure may be implemented in any computer programming language provided that the operating system (OS) provides the facilities that may support the requirements of the present disclosure. An embodiment is implemented in the Java™ computer programming language (or other computer programming languages such as C or C++). (Java and all Java-based trademarks are the trademarks of Sun Microsystems Corporation.) Any limitations presented would be a result of a particular type of operating system or computer programming language and would not be a limitation of the present disclosure.

In accordance with a further embodiment of the present disclosure, there is provided a Voice over Internet Protocol (VoIP) gateway, comprising: a processor; a communications subsystem operatively connected to the processor for communicating with a communications network; a memory operatively connected to the processor, the memory having data and instructions stored thereon to configure the VoIP gateway for: receiving connection instructions from a first communication device, the instructions comprising a connection type of a call, and a contact identifier of a destination communication device of the call. The contact identifier comprises one of: a landline telephone number, a mobile telephone number, an instant messaging (IM) address, and a session initiation protocol uniform resource indicator (SIP URI). The connection type is one of a: direct call from the first communication device at a phone number associated with the first communication device, a call back to a second communication device at a call back number, and a call-in from a second communication device at a call-in number.

The VoIP gateway is further configured for, if the connection type in the connection instructions specifies a direct call, receiving an inbound call from the first communication device from the phone number of the communication device, and initiating an outbound call to the contact identifier when the inbound call from the communication device is received, and bridge the inbound and outbound calls. If the connection type in the connection instructions specifies a call back, the VoIP gateway initiates an outbound call to the call back number, initiating an outbound call to the contact identifier when an outbound call to the second communication device is connected, and bridging the outbound calls. If the connection type in the connection instructions specifies a call-in, the VoIP gateway receives an inbound call from the second communication device from the call-in number, initiating an outbound call to the contact identifier when an inbound call from the second communication device is connected, and bridging the inbound and outbound calls.

In at least some embodiments, if the contact identifier is a landline telephone number, the VoIP gateway initiates the outbound call to a respective landline telephone associated with the contact identifier via a public switched telephone network (PSTN); if the contact identifier is a mobile telephone number, the VoIP gateway initiates the outbound call to a respective mobile telephone associated with the contact identifier via a wireless communications network; if the contact identifier is an IM address, the VoIP gateway initiates the outbound call to a respective Voice over Instant Messaging (VoIM) client via a VoIM network associated with the contact identifier; and if the contact identifier is an SIP URI, the VoIP gateway initiates the outbound call to an SIP-compatible VoIP phone or SIP softphone associated with the contact identifier via the Internet.

In accordance with a further embodiment of the present disclosure, there is provided a communication system, comprising: (a) a Voice over Internet Protocol (VoIP) gateway as described in the preceding paragraphs; (b) a network server connected to the VoIP gateway; and (c) a transcoder. The network server comprises: a processor; a communications subsystem operatively connected to the processor for communicating with the communications network; a memory operatively connected to the processor, the memory having data and instructions stored thereon to configure the network server for: determining a Voice over Instant Messaging (VoIM) network associated with contact identifier represented by an IM address; and establishing a SIP session between the VoIM client in the VoIM network and the originating first or second communication device.

The transcoder is configured for: transcoding SIP-compatible voice data packets of the VoIP gateway into VoIM voice data packets compatible with the respective VoIM network in accordance with an encodation protocol of the respective VoIM network; transmitting transcoded VoIM voice data packets to the respective VoIM network; transcoding voice data packets of the respective VoIM network into SIP-compatible voice data packets; transmitting transcoded SIP-compatible voice data packets to the respective VoIM network to the respective VoIP gateway.

The communication system may comprise telephones and voice clients connectable to the VoIP gateway via a communications network.

The term “callers” is sometimes used herein. It will be appreciated by persons skilled in the art that the term “callers” refers to all parties to the voice call, i.e. the calling party and the one or more called parties. Moreover, the term “telephone” refers to any telephone including landline/PSTN telephones, mobile telephones including a smartphone having both data and voice capabilities and VoIP telephones. The term “voice client” refers to any software having capabilities for conducting a voice-based communication including a VoIP softphone or SIP client, or a VoIM client. Moreover, the term “destination identifier” is sometimes used to refer to the contact identifier of a destination user (intended recipient) of an SMS/MMS/email or IM message or “called party” of a calling party. The contact identifier for a voice call may be a telephone number (i.e., mobile telephone number, landline telephone number, or VoIP telephone number in accordance with E.123), an instant messaging (IM) address and a session initiation protocol uniform resource indicator (SIP URI).

While the present disclosure is primarily described as a method, a person of ordinary skill in the art will understand that the present disclosure is also directed to apparatus such as a computer, a mobile communication device, and a server for carrying out at least some of the aspects and features of the described methods and including components for performing at least some of the described method steps, be it by way of hardware components, a computer programmed by appropriate software to enable the practice of the disclosed method, by any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the disclosed method. It is understood that such apparatus, articles of manufacture, and computer data signals also come within the scope of the present disclosure.

The embodiments of the present disclosure described above are intended to be examples only. Those of skill in the art may effect alterations, modifications and variations to the particular embodiments without departing from the intended scope of the present disclosure. In particular, features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole. The subject matter described herein and in the recited claims intends to cover and embrace all suitable changes in technology.

1. A method for targeted advertising in a communication system for connecting a voice call, the method comprising:
receiving a request to connect a voice call between a first communication device and a second communication device identified by a contact identifier;
establishing a voice connection between the first communication device and a Voice over Internet Protocol (VoIP) gateway;
transmitting a first audio advertisement over the voice connection between the first communication device and the VoIP gateway to be played on the first communication device;
establishing a voice connection between the second communication device and the VoIP gateway; and
connecting the voice call between the first communication device and the second communication device.

2. The method of claim 1, further comprising:
selecting the first audio advertisement in accordance with demographic information associated with the user of one or both of the first communication device and a second communication device.

3. The method of claim 1, further comprising:
requesting input from the first communication device indicating whether a first message comprising further information relating to the first audio advertisement may be transmitted to the first communication device;
if input indicating the first message may be transmitted is received, transmitting the first message to the first communication device.

4. The method of claim 3, wherein the first message is an SMS (Short Messaging System) message, MMS (Multimedia Messaging System) message, instant messaging (IM) message or email message.

5. The method of claim 4, wherein the first message is selected from an SMS message, MMS message, IM message and email message in accordance with the technical capabilities of the first communication device.

6. The method of claim 4, wherein the first message is selected from an SMS message, MMS message, IM message and email message in accordance with stored preferences of an advertiser associated with the first message.

7. The method of claim 4, wherein the first message is selected from an SMS message, MMS message, IM message and email message in accordance with the technical capabilities of the first communication device and stored preferences of an advertiser associated with the first message.

8. The method of claim 3, further comprising:
receiving a reply to the first message from the first communication device;
selecting a further message from a plurality of further messages in accordance with the content of the reply; and
transmitting the further message to the first communication device.

9. The method of claim 8, wherein the further message comprises a coupon or a hyperlink to a coupon.

10. The method of claim 9, wherein the content of the first message includes a plurality of strings and in association with an indication of the content of a further message associated with each string in the plurality of strings, wherein the further message is selected from the plurality of further messages in accordance with a string in the reply.

11. The method of claim 8, wherein the first message comprising an invitation for extended information, the further message comprises the extended information.

12. The method of claim 11, wherein the extended information comprises one or both of a map of a location of the advertiser associated with the first message and directions to the location of the advertiser associated with the first message advertiser associated with the first message.

13. The method of claim 1, further comprising:
transmitting a second audio advertisement over the voice connection between the second communication device and the VoIP gateway to be played on the second communication device.

14. The method of claim 13, further comprising:
selecting the second audio advertisement in accordance with demographic information associated with the user of one or both of the first communication device and a second communication device.

15. The method of claim 13, further comprising:
requesting input from the second communication device indicating whether a second message comprising further information relating to the second audio advertisement may be transmitted to the second communication device;
if input indicating the second message may be transmitted is received, transmitting the second message to the second communication device.

16. The method of claim 15, further comprising:
receiving a reply to the second message from the second communication device;
selecting a further message from a plurality of further messages in accordance with the content of the reply; and
transmitting the further message to the second communication device.

17. The method of claim 1, wherein the contact identifier is one of a telephone number, an instant messaging (IM) address and a session initiation protocol uniform resource indicator (SIP URI).

18. The method of claim 1, further comprising:
after the voice call between the first communication device and the second communication device is terminated;
establishing a voice connection between the VoIP gateway and an advertiser voice communication device; and
connecting the first communication device to the advertiser voice communication device.

19. The method of claim 18, wherein the advertiser voice communication device comprises a telephone or an interactive voice response (IVR) system.

20. The method of claim 18, further comprising:
determining whether to establish a voice connection with a telephone or an IVR system of the advertiser system in accordance with presence information about the advertiser communication device; and
connecting the first communication device to the determined one of the telephone and IVR system.

21. The method of claim 18, further comprising:
requesting input from the first communication device indicating whether to connect to the advertiser voice communication device;
if input to connect to the advertiser voice communication device is received or a predetermined period of time from the request has expired, connecting the first communication device to the advertiser voice communication device.

22. The method of claim 1, further comprising:
after the voice call between the first communication device and the second communication device is terminated,
establishing a voice connection between the VoIP gateway and an advertiser voice communication system;
connecting the second communication device to the advertiser voice communication system.

23. The method of claim 1, further comprising:
establishing an instant messaging (IM) session between at least one of the first and second communication devices and an advertiser computing device using respective IM clients on the at least one of the first and second communication devices first communication device and the advertiser computing device.

24. The method of claim 23, further comprising:
determining if an IM client is available on the at least one of the first and second communication devices; and
determining preferences associated with the advertiser computing device regarding establishing an IM session;
wherein the IM session is established if an IM client is available on the at least one of the first and second communication devices and the determined preferences indicate an IM session is to be established.

25. The method of claim 23, further comprising:
requesting input from the first communication device indicating whether to connect to the advertiser computing device for the IM session;
if input to connect to the advertiser computing device is received or a predetermined period of time from the request has expired, establishing the IM session between the at least one of the first and second communication devices and the advertiser computing device.

26. A server for implementing a targeted advertising in a communication system for connecting a voice call, the server being connected to a plurality of telephones and voice clients over a communication network, the server comprising:
a controller comprising at least one processor, for controlling operation of the server;
one or more input devices connected to the processor;
a communications subsystem operatively connected to the processor for communicating with the communication network;
the controller being configured to receive a receive a request to connect a voice call between a first communication device and a second communication device identified by a contact identifier, establish a voice connection between the first communication device and a Voice over Internet Protocol (VoIP) gateway, transmit a first audio advertisement over the voice connection between the first communication device and the VoIP gateway to be played on the first communication device, establish a voice connection between the second communication device and the VoIP gateway, and connect the voice call between the first communication device and the second communication device.

27. A communication device, comprising:
a controller comprising at least one processor, for controlling operation of the communication device;
a display connected to the processor;
an audio output device connected to the processor;
one or more input devices connected to the processor;
a communications subsystem operatively connected to the processor for communicating with the communications network;
the controller being configured to transmit instructions to connect a voice call between with a second communication device identified by a contact identifier, establish a voice connection between the first communication device and a Voice over Internet Protocol (VoIP) gateway, receive a first audio advertisement from the VoIP gateway over the voice connection, and play the first audio advertisement on the audio output device.

28. The communication device of claim 27, wherein the controller is configured to:
receive an offer to receive a message comprising further information relating to the first audio advertisement;
receive input indicating whether to accept or decline the offer;
transmit an accept or decline response in accordance with the input received; and
receive the message further information if an accept response was transmitted.

29. The communication device of claim 28, wherein the message is an SMS message, MMS message, IM message or email message.

30. The communication device of claim 28, wherein the message comprises an invitation for extended information, the further message comprising the extended information, wherein the message further comprises a plurality of strings and in association with an indication of the content of a further message, wherein the controller is configured to:
transmit a reply to the message; and
receive a further message in accordance with a string in the reply.

31. The communication device of claim 30, wherein the further message comprises a coupon or a hyperlink to a coupon.

32. The communication device of claim 30, wherein the further message is selected from the plurality of further messages in accordance with the string in the reply.

33. The communication device of claim 30, wherein the extended information comprises one or both of a map of a location of the advertiser associated with the second message and directions to the location of the advertiser associated with the second message advertiser associated with the second message.

34. The communication device of claim 28, wherein the controller is configured to:
receive an offer to establish a voice connection with an advertiser voice communication device;
receive input indicating whether to accept or decline the offer;
transmit an accept or decline response in accordance with the input received; and
connect to the advertiser voice communication device if an accept response was transmitted.

35. The communication device of claim 28, wherein the controller is configured to:
receive an offer to establish an instant messaging (IM) session an advertiser computing device;
receive input indicating whether to accept or decline the offer;
transmit an accept or decline response in accordance with the input received; and
connect to the instant messaging (IM) session if an accept response was transmitted.

36. The communication device of claim 27, wherein the communication device is a handheld communication device having voice and data communication capabilities.

37. The communication device of claim 27, wherein the communications device comprises an SIP (session initiation protocol) client or Voice over Instant Messaging (VoIM client).
